(19) United States
(12) Patent Application Publication
(10) Pub. No.: US 2015/0016500 A1
(43) Pub. Date: Jan. 15, 2015

(54) DEVICE AND METHOD FOR SCALABLE CODING OF VIDEO INFORMATION

(71) Applicant: QUALCOMM Incorporated, San Diego, CA (US)

(72) Inventors: Vadim SEREGIN, San Diego, CA (US); Ying CHEN, San Diego, CA (US); Ye-Kui WANG, San Diego, CA (US)

(21) Appl. No.: 14/322,786

(22) Filed: Jul. 2, 2014

Related U.S. Application Data
(60) Provisional application No. 61/845,060, filed on Jul. 11, 2013.

(51) Int. Cl. H04N 19/30; H04N 19/29; H04N 19/187

(52) U.S. Cl. CPC H04N 19/00424; H04N 19/00321; H04N 19/00418
USPC 375/240.02

(57) ABSTRACT

An apparatus configured to code video information includes a memory unit and a processor in communication with the memory unit. The memory unit is configured to store video information associated with a first layer and a second layer. The processor is configured to decode first layer pictures of the first layer, store the decoded first layer pictures in a decoded picture buffer, determine whether second layer pictures having no corresponding first layer pictures are to be coded, and in response to determining that second layer pictures having no corresponding first layer pictures are to be coded, process an indication that one or more decoded first layer pictures stored in the decoded picture buffer are to be removed. The processor may encode or decode the video information.

### CROSS-REFERENCE TO RELATED APPLICATIONS

This application claims priority to U.S. Provisional No. 61/845,060, filed Jul. 11, 2013.

### TECHNICAL FIELD

This disclosure relates to the field of video coding and compression, particularly to scalable video coding (SVC) or multiview video coding (MVC, 3DV).

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video compression techniques perform spatial (intra-picture) prediction and/or temporal (inter-picture) prediction to reduce or remove redundancy inherent in video sequences. For block-based video coding, a video slice (e.g., a video frame, a portion of a video frame, etc.) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy encoding may be applied to achieve even more compression.

### SUMMARY

In video coding, a video application for processing a video stream (e.g., a video conferencing application, movie streaming, etc.) may switch between a lower resolution mode (e.g., in which lower resolution pictures are processed and displayed) and a higher resolution mode (e.g., in which higher resolution pictures are processed and displayed) depending on bandwidth conditions. If the bandwidth initially cannot support higher resolution streaming, the application may process the video stream in the lower resolution mode, and when the bandwidth improves, the application may switch to the higher resolution mode so that it can display a higher quality video.

Generally, pictures that have been coded can be stored in a decoded picture buffer (DPB) so that they can be used to code other pictures. For example, a video coder may use pixel values or other information (e.g., motion information) of previously coded pictures stored in the DPB to code subsequent pictures. However, the DPB has limited space, and not all coded pictures can be stored in the DPB. Therefore, timely removing unnecessary pictures from the DPB can improve DPB management and memory usage.

In addition, in scalable extension (SHVC) of high efficiency vide coding (HEVC), when the video application switches from the lower resolution mode to the higher resolution mode, the application may stop managing the lower resolution pictures stored in the DPB (e.g., it may not clear out the lower resolution pictures that may remain in the DPB). In such a situation, the lower resolution pictures may unnecessarily remain in the DPB, leaving less space in the DPB for higher resolution pictures. In another example, the lower resolution pictures stored in the DPB may be cleared before any of the higher resolution pictures is coded, rendering them unavailable for use in the coding of the higher resolution pictures. In such a situation, the coding efficiency may suffer since the higher resolution pictures would have to be coded using intra prediction, which is generally more costly than inter prediction or inter-layer prediction.

Therefore, by properly managing the lower resolution pictures stored in the DPB when there is a resolution change, memory usage and coding efficiency may be improved.

The systems, methods and devices of this disclosure each have several innovative aspects, no single one of which is solely responsible for the desirable attributes disclosed herein.

In one embodiment, an apparatus configured to code (e.g., encode or decode) video information includes a memory unit and a processor in communication with the memory unit. The memory unit is configured to store video information associated with a first layer and a second layer. The processor is configured to decode first layer pictures of the first layer, store the decoded first layer pictures in a decoded picture buffer, determine whether second layer pictures having no corresponding first layer pictures are to be coded, and in response to determining that second layer pictures having no corresponding first layer pictures are to be coded, process an indication that one or more decoded first layer pictures stored in the decoded picture buffer are to be removed. The processor may encode or decode the video information.

In one embodiment, a method of coding (e.g., encoding or decoding) video information comprises storing video information associated with at least one of a first layer and a second layer, the first layer comprising first layer pictures and the second layer comprising second layer pictures; decoding one or more of the first layer pictures of the first layer; storing the one or more decoded first layer pictures in a decoded picture buffer; determining that at least one of the second layer pictures having no corresponding first layer picture is to be coded; and in response to determining that at least one of the second layer pictures having no corresponding first layer picture is to be coded, processing an indication that at least one of the one or more decoded first layer pictures stored in the decoded picture buffer is to be removed from the decoded picture buffer.

In one embodiment, a non-transitory computer readable medium comprises code that, when executed, causes an apparatus to perform a process. The process includes storing video information associated with at least one of a first layer and a second layer, the first layer comprising first layer pictures and the second layer comprising second layer pictures; decoding one or more of the first layer pictures of the first layer; storing the one or more decoded first layer pictures in a decoded picture buffer; determining that at least one of the second layer pictures having no corresponding first layer picture is to be coded; and in response to determining that at least one of the second layer pictures having no corresponding first layer picture is to be coded, processing an indication that at least one of the one or more decoded first layer pictures stored in the decoded picture buffer is to be removed from the decoded picture buffer.

In one embodiment, a video coding device configured to code video information comprises means for storing video information associated with at least one of a first layer and a second layer, the first layer comprising first layer pictures and the second layer comprising second layer pictures; means for decoding one or more of the first layer pictures of the first layer; means for storing the one or more decoded first layer pictures in a decoded picture buffer; means for determining that at least one of the second layer pictures having no corresponding first layer picture is to be coded; means for processing an indication, in response to determining that at least one of the second layer pictures having no corresponding first layer picture is to be coded, that at least one of the one or more decoded first layer pictures stored in the decoded picture buffer is to be removed from the decoded picture buffer.

### BRIEF DESCRIPTION OF DRAWINGS

FIG. 1A is a block diagram illustrating an example video encoding and decoding system that may utilize techniques in accordance with aspects described in this disclosure.

FIG. 1B is a block diagram illustrating another example video encoding and decoding system that may perform techniques in accordance with aspects described in this disclosure.

FIG. 2A is a block diagram illustrating an example of a video encoder that may implement techniques in accordance with aspects described in this disclosure.

FIG. 2B is a block diagram illustrating an example of a video encoder that may implement techniques in accordance with aspects described in this disclosure.

FIG. 3A is a block diagram illustrating an example of a video decoder that may implement techniques in accordance with aspects described in this disclosure.

FIG. 3B is a block diagram illustrating an example of a video decoder that may implement techniques in accordance with aspects described in this disclosure.

FIG. 4 is a schematic diagram illustrating various pictures in a lower layer and an upper layer, according to one embodiment of the present disclosure.

FIG. 5 is a schematic diagram illustrating various pictures in a lower layer and an upper layer, according to one embodiment of the present disclosure.

FIG. 6 is a schematic diagram illustrating various pictures in a lower layer and an upper layer, according to one embodiment of the present disclosure.

FIGS. 7A and 7B illustrate a flow chart illustrating a method of coding video information, according to one embodiment of the present disclosure.

### DETAILED DESCRIPTION

Certain embodiments described herein relate to inter-layer prediction for scalable video coding in the context of advanced video codecs, such as HEVC (High Efficiency Video Coding). More specifically, the present disclosure relates to systems and methods for improved performance of inter-layer prediction in scalable video coding (SHVC) extension of HEVC.

In the description below, H.264/AVC techniques related to certain embodiments are described; the HEVC standard and related techniques are also discussed. While certain embodiments are described herein in the context of the HEVC and/or H.264 standards, one having ordinary skill in the art may appreciate that systems and methods disclosed herein may be applicable to any suitable video coding standard. For example, embodiments disclosed herein may be applicable to one or more of the following standards: ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

HEVC generally follows the framework of previous video coding standards in many respects. The unit of prediction in HEVC is different from that in certain previous video coding standards (e.g., macroblock). In fact, the concept of macroblock does not exist in HEVC as understood in certain previous video coding standards. Macroblock is replaced by a hierarchical structure based on a quadtree scheme, which may provide high flexibility, among other possible benefits. For example, within the HEVC scheme, three types of blocks, Coding Unit (CU), Prediction Unit (PU), and Transform Unit (TU), are defined. CU may refer to the basic unit of region splitting. CU may be considered analogous to the concept of macroblock, but it does not restrict the maximum size and may allow recursive splitting into four equal size CUs to improve the content adaptivity. PU may be considered the basic unit of inter/intra prediction and it may contain multiple arbitrary shape partitions in a single PU to effectively code irregular image patterns. TU may be considered the basic unit of transform. It can be defined independently from the PU; however, its size may be limited to the CU to which the TU belongs. This separation of the block structure into three different concepts may allow each to be optimized according to its role, which may result in improved coding efficiency.

For purposes of illustration only, certain embodiments disclosed herein are described with examples including only two layers (e.g., a lower layer such as the base layer, and a higher layer such as the enhancement layer). It should be understood that such examples may be applicable to configurations including multiple base and/or enhancement layers. In addition, for ease of explanation, the following disclosure includes the terms “frames” or “blocks” with reference to certain embodiments. However, these terms are not meant to be limiting. For example, the techniques described below can be used with any suitable video units, such as blocks (e.g., CU, PU, TU, macroblocks, etc.), slices, frames, etc.

### Video Coding Standards

A digital image, such as a video image, a TV image, a still image or an image generated by a video recorder or a computer, may consist of pixels or samples arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). The full citation for the HEVC Draft 10 is document JCTVC-L1003, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, Jan. 14, 2013 to Jan. 23, 2013. The multiview extension to HEVC, namely MV-HEVC, and the scalable extension to HEVC, named SHVC, are also being developed by the JCT-3V (ITU-T/ISO/IEC Joint Collaborative Team on 3D Video Coding Extension Development) and JCT-VC, respectively.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

### Video Coding System

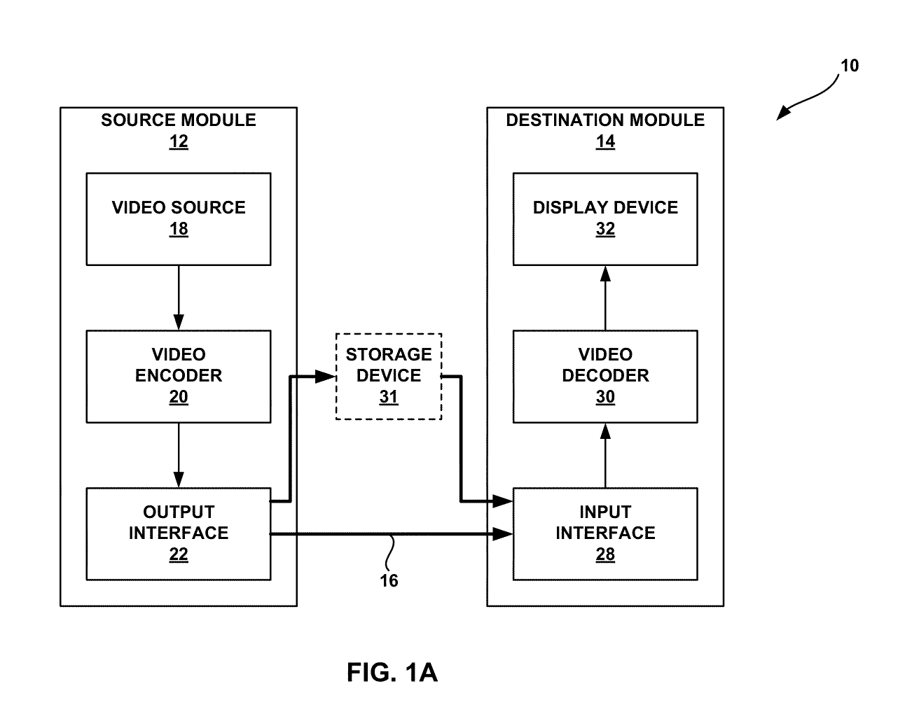

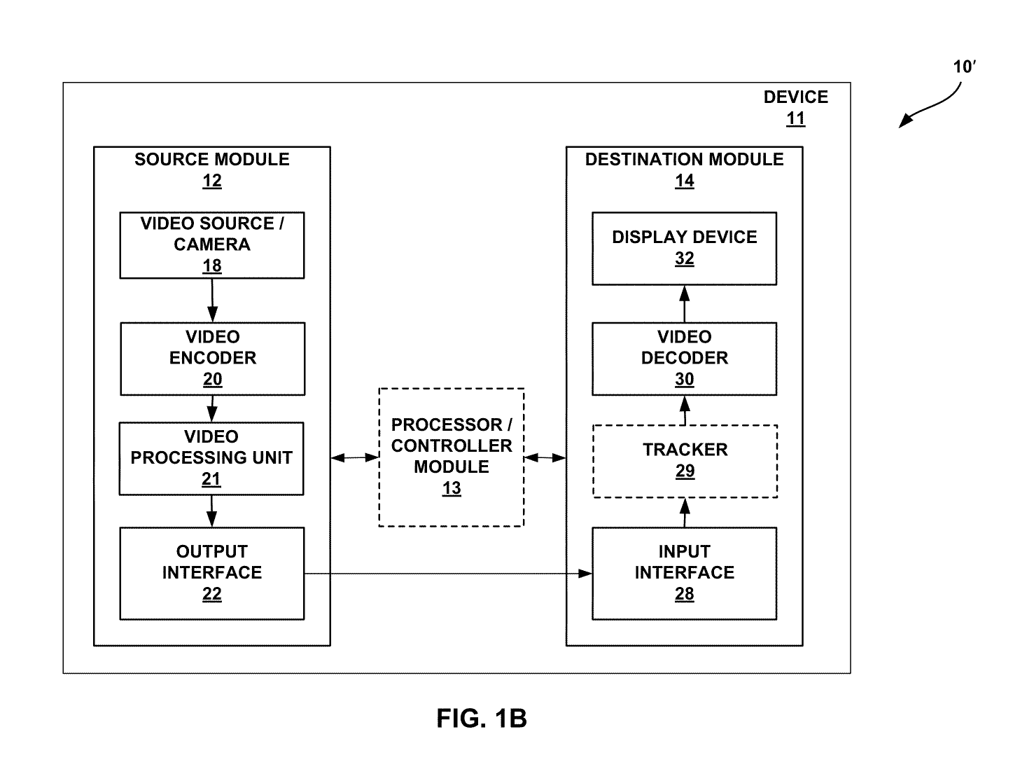

FIG. 1A is a block diagram that illustrates an example video coding system 10 that may utilize techniques in accordance with aspects described in this disclosure. As used described herein, the term “video coder” refers generically to both video encoders and video decoders. In this disclosure, the terms “video coding” or “coding” may refer generically to video encoding and video decoding.

As shown in FIG. 1A, video coding system 10 includes a source module 12 that generates encoded video data to be decoded at a later time by a destination module 14. In the example of FIG. 1A, the source module 12 and destination module 14 are on separate devices—specifically, the source module 12 is part of a source device, and the destination module 14 is part of a destination device. It is noted, however, that the source and destination modules 12, 14 may be on or part of the same device, as shown in the example of FIG. 1B.

With reference once again, to FIG. 1A, the source module 12 and the destination module 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source module 12 and the destination module 14 may be equipped for wireless communication.

The destination module 14 may receive the encoded video data to be decoded via a link 16. The link 16 may comprise any type of medium or device capable of moving the encoded video data from the source module 12 to the destination module 14. In the example of FIG. 1A, the link 16 may comprise a communication medium to enable the source module 12 to transmit encoded video data directly to the destination module 14 in real-time. The encoded video data may be modulated according to a communication standard, such as a wireless communication protocol, and transmitted to the destination module 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source module 12 to the destination module 14.

Alternatively, encoded data may be output from an output interface 22 to an optional storage device 31. Similarly, encoded data may be accessed from the storage device 31 by an input interface 28. The storage device 31 may include any of a variety of distributed or locally accessed data storage media such as a hard drive, flash memory, volatile or non-volatile memory, or any other suitable digital storage media for storing encoded video data. In a further example, the storage device 31 may correspond to a file server or another intermediate storage device that may hold the encoded video generated by the source module 12. The destination module 14 may access stored video data from the storage device 31 via streaming or download. The file server may be any type of server capable of storing encoded video data and transmitting that encoded video data to the destination module 14. Example file servers include a web server (e.g., for a website), an FTP server, network attached storage (NAS) devices, or a local disk drive. The destination module 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device 31 may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet (e.g., dynamic adaptive streaming over HTTP (DASH), etc.), encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1A, the source module 12 includes a video source 18, video encoder 20 and an output interface 22. In some cases, the output interface 22 may include a modulator/demodulator (modem) and/or a transmitter. In the source module 12, the video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if the video source 18 is a video camera, the source module 12 and the destination module 14 may form so-called camera phones or video phones, as illustrated in the example of FIG. 1B. However, the techniques described in this disclosure may be applicable to video coding in general, and may be applied to wireless and/or wired applications.

The captured, pre-captured, or computer-generated video may be encoded by the video encoder 20. The encoded video data may be transmitted directly to the destination module 14 via the output interface 22 of the source module 12. The encoded video data may also (or alternatively) be stored onto the storage device 31 for later access by the destination module 14 or other devices, for decoding and/or playback.

In the example of FIG. 1A, the destination module 14 includes an input interface 28, a video decoder 30, and a display device 32. In some cases, the input interface 28 may include a receiver and/or a modem. The input interface 28 of the destination module 14 may receive the encoded video data over the link 16. The encoded video data communicated over the link 16, or provided on the storage device 31, may include a variety of syntax elements generated by the video encoder 20 for use by a video decoder, such as the video decoder 30, in decoding the video data. Such syntax elements may be included with the encoded video data transmitted on a communication medium, stored on a storage medium, or stored a file server.

The display device 32 may be integrated with, or external to, the destination module 14. In some examples, the destination module 14 may include an integrated display device and also be configured to interface with an external display device. In other examples, the destination module 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In related aspects, FIG. 1B shows an example video encoding and decoding system 10′ wherein the source and destination modules 12, 14 are on or part of a device or user device 11. The device 11 may be a telephone handset, such as a “smart” phone or the like. The device 11 may include an optional controller/processor module 13 in operative communication with the source and destination modules 12, 14. The system 10′ of FIG. 1B may further include a video processing unit 21 between the video encoder 20 and the output interface 22. In some implementations, the video processing unit 21 is a separate unit, as illustrated in FIG. 1B; however, in other implementations, the video processing unit 21 can be implemented as a portion of the video encoder 20 and/or the processor/controller module 13. The system 10′ may also include an optional tracker 29, which can track an object of interest in a video sequence. The object or interest to be tracked may be segmented by a technique described in connection with one or more aspects of the present disclosure. In related aspects, the tracking may be performed by the display device 32, alone or in conjunction with the tracker 29. The system 10′ of FIG. 1B, and components thereof, are otherwise similar to the system 10 of FIG. 1A, and components thereof.

Video encoder 20 and video decoder 30 may operate according to a video compression standard, such as the High Efficiency Video Coding (HEVC) standard presently under development, and may conform to a HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the examples of FIGS. 1A and 1B, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

### Video Coding Process

As mentioned briefly above, video encoder 20 encodes video data. The video data may comprise one or more pictures. Each of the pictures is a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture.

To generate the bitstream, video encoder 20 may perform encoding operations on each picture in the video data. When video encoder 20 performs encoding operations on the pictures, video encoder 20 may generate a series of coded pictures and associated data. The associated data may include video parameter sets (VPS), sequence parameter sets, picture parameter sets, adaptation parameter sets, and other syntax structures. A sequence parameter set (SPS) may contain parameters applicable to zero or more sequences of pictures. A picture parameter set (PPS) may contain parameters applicable to zero or more pictures. An adaptation parameter set (APS) may contain parameters applicable to zero or more pictures. Parameters in an APS may be parameters that are more likely to change than parameters in a PPS.

To generate a coded picture, video encoder 20 may partition a picture into equally-sized video blocks. A video block may be a two-dimensional array of samples. Each of the video blocks is associated with a treeblock. In some instances, a treeblock may be referred to as a largest coding unit (LCU). The treeblocks of HEVC may be broadly analogous to the macroblocks of previous standards, such as H.264/AVC. However, a treeblock is not necessarily limited to a particular size and may include one or more coding units (CUs). Video encoder 20 may use quadtree partitioning to partition the video blocks of treeblocks into video blocks associated with CUs, hence the name “treeblocks.”

In some examples, video encoder 20 may partition a picture into a plurality of slices. Each of the slices may include an integer number of CUs. In some instances, a slice comprises an integer number of treeblocks. In other instances, a boundary of a slice may be within a treeblock.

As part of performing an encoding operation on a picture, video encoder 20 may perform encoding operations on each slice of the picture. When video encoder 20 performs an encoding operation on a slice, video encoder 20 may generate encoded data associated with the slice. The encoded data associated with the slice may be referred to as a “coded slice.”

To generate a coded slice, video encoder 20 may perform encoding operations on each treeblock in a slice. When video encoder 20 performs an encoding operation on a treeblock, video encoder 20 may generate a coded treeblock. The coded treeblock may comprise data representing an encoded version of the treeblock.

When video encoder 20 generates a coded slice, video encoder 20 may perform encoding operations on (e.g., encode) the treeblocks in the slice according to a raster scan order. For example, video encoder 20 may encode the treeblocks of the slice in an order that proceeds from left to right across a topmost row of treeblocks in the slice, then from left to right across a next lower row of treeblocks, and so on until video encoder 20 has encoded each of the treeblocks in the slice.

As a result of encoding the treeblocks according to the raster scan order, the treeblocks above and to the left of a given treeblock may have been encoded, but treeblocks below and to the right of the given treeblock have not yet been encoded. Consequently, video encoder 20 may be able to access information generated by encoding treeblocks above and to the left of the given treeblock when encoding the given treeblock. However, video encoder 20 may be unable to access information generated by encoding treeblocks below and to the right of the given treeblock when encoding the given treeblock.

To generate a coded treeblock, video encoder 20 may recursively perform quadtree partitioning on the video block of the treeblock to divide the video block into progressively smaller video blocks. Each of the smaller video blocks may be associated with a different CU. For example, video encoder 20 may partition the video block of a treeblock into four equally-sized sub-blocks, partition one or more of the sub-blocks into four equally-sized sub-sub-blocks, and so on. A partitioned CU may be a CU whose video block is partitioned into video blocks associated with other CUs. A non-partitioned CU may be a CU whose video block is not partitioned into video blocks associated with other CUs.

One or more syntax elements in the bitstream may indicate a maximum number of times video encoder 20 may partition the video block of a treeblock. A video block of a CU may be square in shape. The size of the video block of a CU (e.g., the size of the CU) may range from 8×8 pixels up to the size of a video block of a treeblock (e.g., the size of the treeblock) with a maximum of 64×64 pixels or greater.

Video encoder 20 may perform encoding operations on (e.g., encode) each CU of a treeblock according to a z-scan order. In other words, video encoder 20 may encode a top-left CU, a top-right CU, a bottom-left CU, and then a bottom-right CU, in that order. When video encoder 20 performs an encoding operation on a partitioned CU, video encoder 20 may encode CUs associated with sub-blocks of the video block of the partitioned CU according to the z-scan order. In other words, video encoder 20 may encode a CU associated with a top-left sub-block, a CU associated with a top-right sub-block, a CU associated with a bottom-left sub-block, and then a CU associated with a bottom-right sub-block, in that order.

As a result of encoding the CUs of a treeblock according to a z-scan order, the CUs above, above-and-to-the-left, above-and-to-the-right, left, and below-and-to-the left of a given CU may have been encoded. CUs below and to the right of the given CU have not yet been encoded. Consequently, video encoder 20 may be able to access information generated by encoding some CUs that neighbor the given CU when encoding the given CU. However, video encoder 20 may be unable to access information generated by encoding other CUs that neighbor the given CU when encoding the given CU.

When video encoder 20 encodes a non-partitioned CU, video encoder 20 may generate one or more prediction units (PUs) for the CU. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

When video encoder 20 uses intra prediction to generate the predicted video block of a PU, video encoder 20 may generate the predicted video block of the PU based on decoded samples of the picture associated with the PU. If video encoder 20 uses intra prediction to generate predicted video blocks of the PUs of a CU, the CU is an intra-predicted CU. When video encoder 20 uses inter prediction to generate the predicted video block of the PU, video encoder 20 may generate the predicted video block of the PU based on decoded samples of one or more pictures other than the picture associated with the PU. If video encoder 20 uses inter prediction to generate predicted video blocks of the PUs of a CU, the CU is an inter-predicted CU.

Furthermore, when video encoder 20 uses inter prediction to generate a predicted video block for a PU, video encoder 20 may generate motion information for the PU. The motion information for a PU may indicate one or more reference blocks of the PU. Each reference block of the PU may be a video block within a reference picture. The reference picture may be a picture other than the picture associated with the PU. In some instances, a reference block of a PU may also be referred to as the “reference sample” of the PU. Video encoder 20 may generate the predicted video block for the PU based on the reference blocks of the PU.

After video encoder 20 generates predicted video blocks for one or more PUs of a CU, video encoder 20 may generate residual data for the CU based on the predicted video blocks for the PUs of the CU. The residual data for the CU may indicate differences between samples in the predicted video blocks for the PUs of the CU and the original video block of the CU.

Furthermore, as part of performing an encoding operation on a non-partitioned CU, video encoder 20 may perform recursive quadtree partitioning on the residual data of the CU to partition the residual data of the CU into one or more blocks of residual data (e.g., residual video blocks) associated with transform units (TUs) of the CU. Each TU of a CU may be associated with a different residual video block.

Video coder 20 may apply one or more transforms to residual video blocks associated with the TUs to generate transform coefficient blocks (e.g., blocks of transform coefficients) associated with the TUs. Conceptually, a transform coefficient block may be a two-dimensional (2D) matrix of transform coefficients.

After generating a transform coefficient block, video encoder 20 may perform a quantization process on the transform coefficient block. Quantization generally refers to a process in which transform coefficients are quantized to possibly reduce the amount of data used to represent the transform coefficients, providing further compression. The quantization process may reduce the bit depth associated with some or all of the transform coefficients. For example, an n-bit transform coefficient may be rounded down to an m-bit transform coefficient during quantization, where n is greater than m.

Video encoder 20 may associate each CU with a quantization parameter (QP) value. The QP value associated with a CU may determine how video encoder 20 quantizes transform coefficient blocks associated with the CU. Video encoder 20 may adjust the degree of quantization applied to the transform coefficient blocks associated with a CU by adjusting the QP value associated with the CU.

After video encoder 20 quantizes a transform coefficient block, video encoder 20 may generate sets of syntax elements that represent the transform coefficients in the quantized transform coefficient block. Video encoder 20 may apply entropy encoding operations, such as Context Adaptive Binary Arithmetic Coding (CABAC) operations, to some of these syntax elements. Other entropy coding techniques such as content adaptive variable length coding (CAVLC), probability interval partitioning entropy (PIPE) coding, or other binary arithmetic coding could also be used.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a video parameter set, a sequence parameter set, a picture parameter set, a coded slice, supplemental enhancement information (SEI), an access unit delimiter, filler data, or another type of data. The data in a NAL unit may include various syntax structures.

Video decoder 30 may receive the bitstream generated by video encoder 20. The bitstream may include a coded representation of the video data encoded by video encoder 20. When video decoder 30 receives the bitstream, video decoder 30 may perform a parsing operation on the bitstream. When video decoder 30 performs the parsing operation, video decoder 30 may extract syntax elements from the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

After video decoder 30 extracts the syntax elements associated with a CU, video decoder 30 may generate predicted video blocks for the PUs of the CU based on the syntax elements. In addition, video decoder 30 may inverse quantize transform coefficient blocks associated with TUs of the CU. Video decoder 30 may perform inverse transforms on the transform coefficient blocks to reconstruct residual video blocks associated with the TUs of the CU. After generating the predicted video blocks and reconstructing the residual video blocks, video decoder 30 may reconstruct the video block of the CU based on the predicted video blocks and the residual video blocks. In this way, video decoder 30 may reconstruct the video blocks of CUs based on the syntax elements in the bitstream.

### Video Encoder

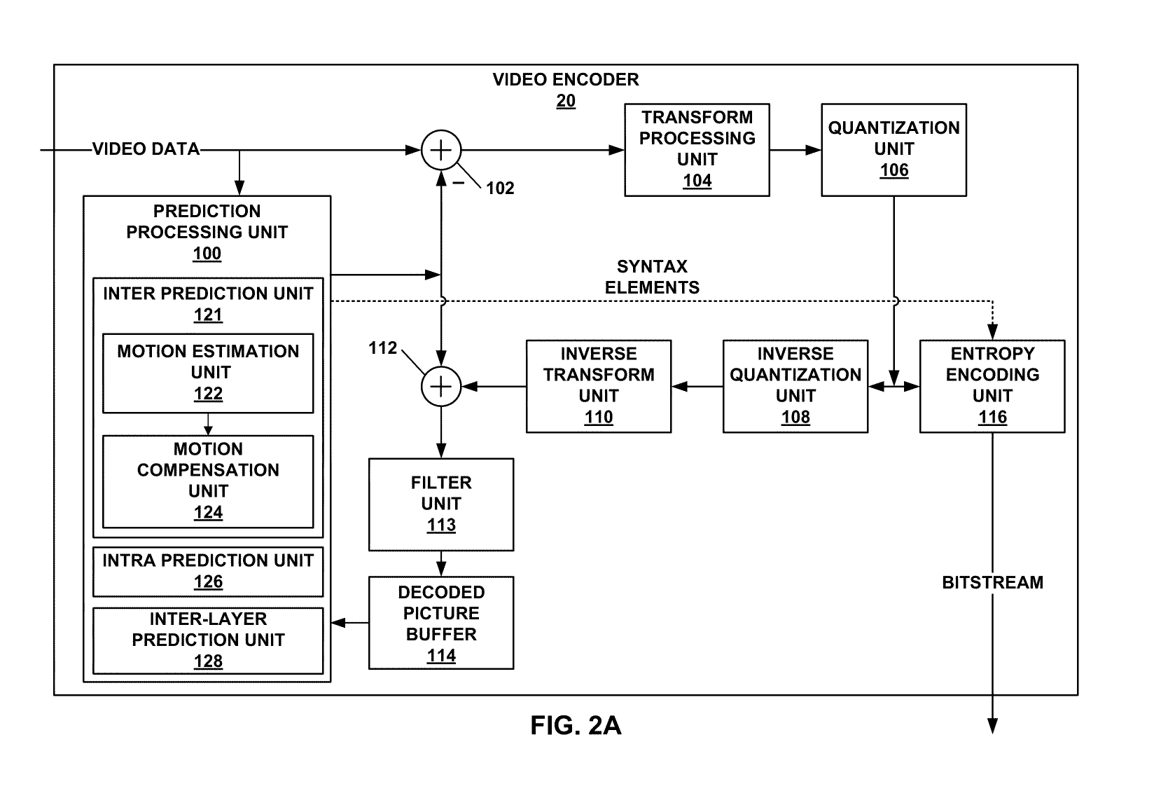

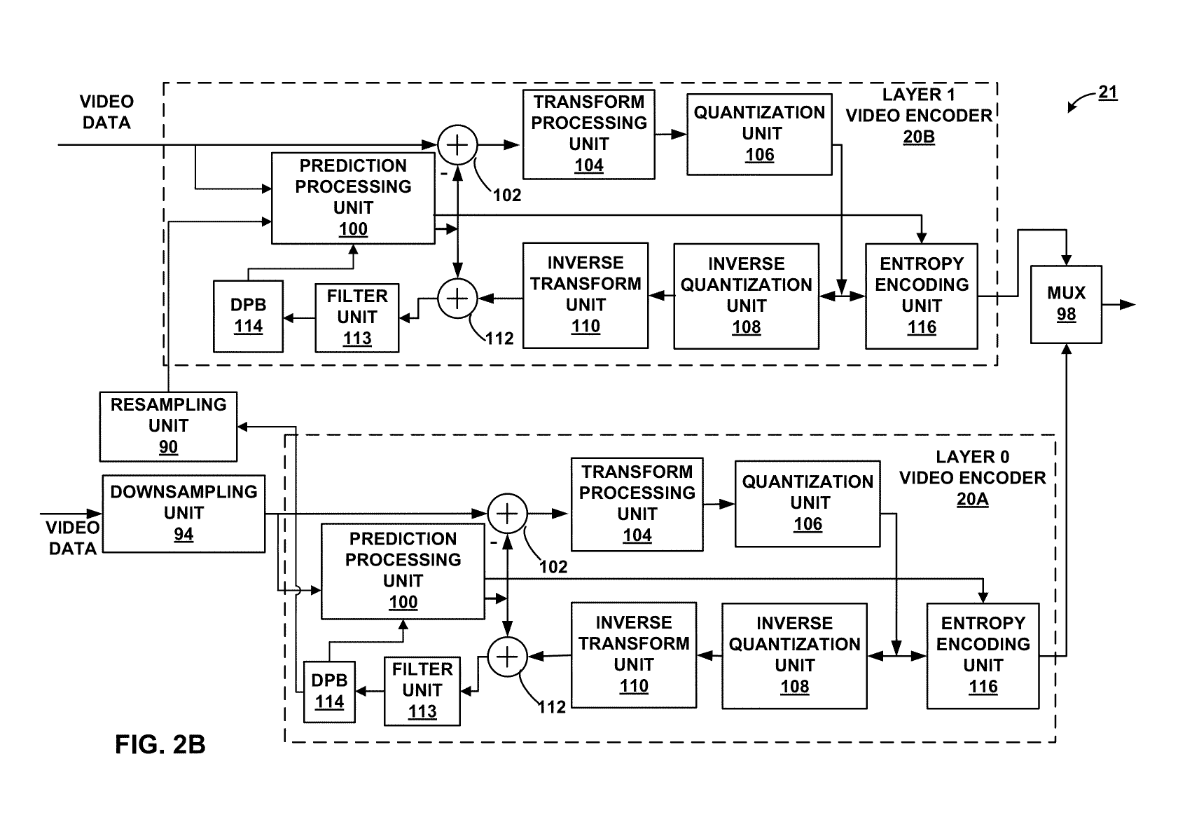

FIG. 2A is a block diagram illustrating an example of a video encoder that may implement techniques in accordance with aspects described in this disclosure. Video encoder 20 may be configured to process a single layer of a video frame, such as for HEVC. Further, video encoder 20 may be configured to perform any or all of the techniques of this disclosure. As one example, prediction processing unit 100 may be configured to perform any or all of the techniques described in this disclosure. In another embodiment, the video encoder 20 includes an optional inter-layer prediction unit 128 that is configured to perform any or all of the techniques described in this disclosure. In other embodiments, inter-layer prediction can be performed by prediction processing unit 100 (e.g., inter prediction unit 121 and/or intra prediction unit 126), in which case the inter-layer prediction unit 128 may be omitted. However, aspects of this disclosure are not so limited. In some examples, the techniques described in this disclosure may be shared among the various components of video encoder 20. In some examples, additionally or alternatively, a processor (not shown) may be configured to perform any or all of the techniques described in this disclosure.

For purposes of explanation, this disclosure describes video encoder 20 in the context of HEVC coding. However, the techniques of this disclosure may be applicable to other coding standards or methods. The example depicted in FIG. 2A is for a single layer codec. However, as will be described further with respect to FIG. 2B, some or all of the video encoder 20 may be duplicated for processing of a multi-layer codec.

Video encoder 20 may perform intra- and inter-coding of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-directional prediction (B mode), may refer to any of several temporal-based coding modes.

In the example of FIG. 2A, video encoder 20 includes a plurality of functional components. The functional components of video encoder 20 include a prediction processing unit 100, a residual generation unit 102, a transform processing unit 104, a quantization unit 106, an inverse quantization unit 108, an inverse transform unit 110, a reconstruction unit 112, a filter unit 113, a decoded picture buffer 114, and an entropy encoding unit 116. Prediction processing unit 100 includes an inter prediction unit 121, a motion estimation unit 122, a motion compensation unit 124, an intra prediction unit 126, and an inter-layer prediction unit 128. In other examples, video encoder 20 may include more, fewer, or different functional components. Furthermore, motion estimation unit 122 and motion compensation unit 124 may be highly integrated, but are represented in the example of FIG. 2A separately for purposes of explanation.

Video encoder 20 may receive video data. Video encoder 20 may receive the video data from various sources. For example, video encoder 20 may receive the video data from video source 18 (e.g., shown in FIG. 1A or 1B) or another source. The video data may represent a series of pictures. To encode the video data, video encoder 20 may perform an encoding operation on each of the pictures. As part of performing the encoding operation on a picture, video encoder 20 may perform encoding operations on each slice of the picture. As part of performing an encoding operation on a slice, video encoder 20 may perform encoding operations on treeblocks in the slice.

As part of performing an encoding operation on a treeblock, prediction processing unit 100 may perform quadtree partitioning on the video block of the treeblock to divide the video block into progressively smaller video blocks. Each of the smaller video blocks may be associated with a different CU. For example, prediction processing unit 100 may partition a video block of a treeblock into four equally-sized sub-blocks, partition one or more of the sub-blocks into four equally-sized sub-sub-blocks, and so on.

The sizes of the video blocks associated with CUs may range from 8×8 samples up to the size of the treeblock with a maximum of 64×64 samples or greater. In this disclosure, “N×N” and “N by N” may be used interchangeably to refer to the sample dimensions of a video block in terms of vertical and horizontal dimensions, e.g., 16×16 samples or 16 by 16 samples. In general, a 16×16 video block has sixteen samples in a vertical direction (y=16) and sixteen samples in a horizontal direction (x=16). Likewise, an N×N block generally has N samples in a vertical direction and N samples in a horizontal direction, where N represents a nonnegative integer value.

Furthermore, as part of performing the encoding operation on a treeblock, prediction processing unit 100 may generate a hierarchical quadtree data structure for the treeblock. For example, a treeblock may correspond to a root node of the quadtree data structure. If prediction processing unit 100 partitions the video block of the treeblock into four sub-blocks, the root node has four child nodes in the quadtree data structure. Each of the child nodes corresponds to a CU associated with one of the sub-blocks. If prediction processing unit 100 partitions one of the sub-blocks into four sub-sub-blocks, the node corresponding to the CU associated with the sub-block may have four child nodes, each of which corresponds to a CU associated with one of the sub-sub-blocks.

Each node of the quadtree data structure may contain syntax data (e.g., syntax elements) for the corresponding treeblock or CU. For example, a node in the quadtree may include a split flag that indicates whether the video block of the CU corresponding to the node is partitioned (e.g., split) into four sub-blocks. Syntax elements for a CU may be defined recursively, and may depend on whether the video block of the CU is split into sub-blocks. A CU whose video block is not partitioned may correspond to a leaf node in the quadtree data structure. A coded treeblock may include data based on the quadtree data structure for a corresponding treeblock.

Video encoder 20 may perform encoding operations on each non-partitioned CU of a treeblock. When video encoder 20 performs an encoding operation on a non-partitioned CU, video encoder 20 generates data representing an encoded representation of the non-partitioned CU.

As part of performing an encoding operation on a CU, prediction processing unit 100 may partition the video block of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, prediction processing unit 100 may perform geometric partitioning to partition the video block of a CU among PUs of the CU along a boundary that does not meet the sides of the video block of the CU at right angles.

Inter prediction unit 121 may perform inter prediction on each PU of the CU. Inter prediction may provide temporal compression. To perform inter prediction on a PU, motion estimation unit 122 may generate motion information for the PU. Motion compensation unit 124 may generate a predicted video block for the PU based the motion information and decoded samples of pictures other than the picture associated with the CU (e.g., reference pictures). In this disclosure, a predicted video block generated by motion compensation unit 124 may be referred to as an inter-predicted video block.

Slices may be I slices, P slices, or B slices. Motion estimation unit 122 and motion compensation unit 124 may perform different operations for a PU of a CU depending on whether the PU is in an I slice, a P slice, or a B slice. In an I slice, all PUs are intra predicted. Hence, if the PU is in an I slice, motion estimation unit 122 and motion compensation unit 124 do not perform inter prediction on the PU.

If the PU is in a P slice, the picture containing the PU is associated with a list of reference pictures referred to as “list 0.” Each of the reference pictures in list 0 contains samples that may be used for inter prediction of other pictures. When motion estimation unit 122 performs the motion estimation operation with regard to a PU in a P slice, motion estimation unit 122 may search the reference pictures in list 0 for a reference block for the PU. The reference block of the PU may be a set of samples, e.g., a block of samples, that most closely corresponds to the samples in the video block of the PU. Motion estimation unit 122 may use a variety of metrics to determine how closely a set of samples in a reference picture corresponds to the samples in the video block of a PU. For example, motion estimation unit 122 may determine how closely a set of samples in a reference picture corresponds to the samples in the video block of a PU by sum of absolute difference (SAD), sum of square difference (SSD), or other difference metrics.

After identifying a reference block of a PU in a P slice, motion estimation unit 122 may generate a reference index that indicates the reference picture in list 0 containing the reference block and a motion vector that indicates a spatial displacement between the PU and the reference block. In various examples, motion estimation unit 122 may generate motion vectors to varying degrees of precision. For example, motion estimation unit 122 may generate motion vectors at one-quarter sample precision, one-eighth sample precision, or other fractional sample precision. In the case of fractional sample precision, reference block values may be interpolated from integer-position sample values in the reference picture. Motion estimation unit 122 may output the reference index and the motion vector as the motion information of the PU. Motion compensation unit 124 may generate a predicted video block of the PU based on the reference block identified by the motion information of the PU.

If the PU is in a B slice, the picture containing the PU may be associated with two lists of reference pictures, referred to as “list 0” and “list 1.” In some examples, a picture containing a B slice may be associated with a list combination that is a combination of list 0 and list 1.

Furthermore, if the PU is in a B slice, motion estimation unit 122 may perform uni-directional prediction or bi-directional prediction for the PU. When motion estimation unit 122 performs uni-directional prediction for the PU, motion estimation unit 122 may search the reference pictures of list 0 or list 1 for a reference block for the PU. Motion estimation unit 122 may then generate a reference index that indicates the reference picture in list 0 or list 1 that contains the reference block and a motion vector that indicates a spatial displacement between the PU and the reference block. Motion estimation unit 122 may output the reference index, a prediction direction indicator, and the motion vector as the motion information of the PU. The prediction direction indicator may indicate whether the reference index indicates a reference picture in list 0 or list 1. Motion compensation unit 124 may generate the predicted video block of the PU based on the reference block indicated by the motion information of the PU.

When motion estimation unit 122 performs bi-directional prediction for a PU, motion estimation unit 122 may search the reference pictures in list 0 for a reference block for the PU and may also search the reference pictures in list 1 for another reference block for the PU. Motion estimation unit 122 may then generate reference indexes that indicate the reference pictures in list 0 and list 1 containing the reference blocks and motion vectors that indicate spatial displacements between the reference blocks and the PU. Motion estimation unit 122 may output the reference indexes and the motion vectors of the PU as the motion information of the PU. Motion compensation unit 124 may generate the predicted video block of the PU based on the reference blocks indicated by the motion information of the PU.

In some instances, motion estimation unit 122 does not output a full set of motion information for a PU to entropy encoding unit 116. Rather, motion estimation unit 122 may signal the motion information of a PU with reference to the motion information of another PU. For example, motion estimation unit 122 may determine that the motion information of the PU is sufficiently similar to the motion information of a neighboring PU. In this example, motion estimation unit 122 may indicate, in a syntax structure associated with the PU, a value that indicates to video decoder 30 that the PU has the same motion information as the neighboring PU. In another example, motion estimation unit 122 may identify, in a syntax structure associated with the PU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to determine the motion vector of the PU. By referring to the motion information of a first PU when signaling the motion information of a second PU, video encoder 20 may be able to signal the motion information of the second PU using fewer bits.

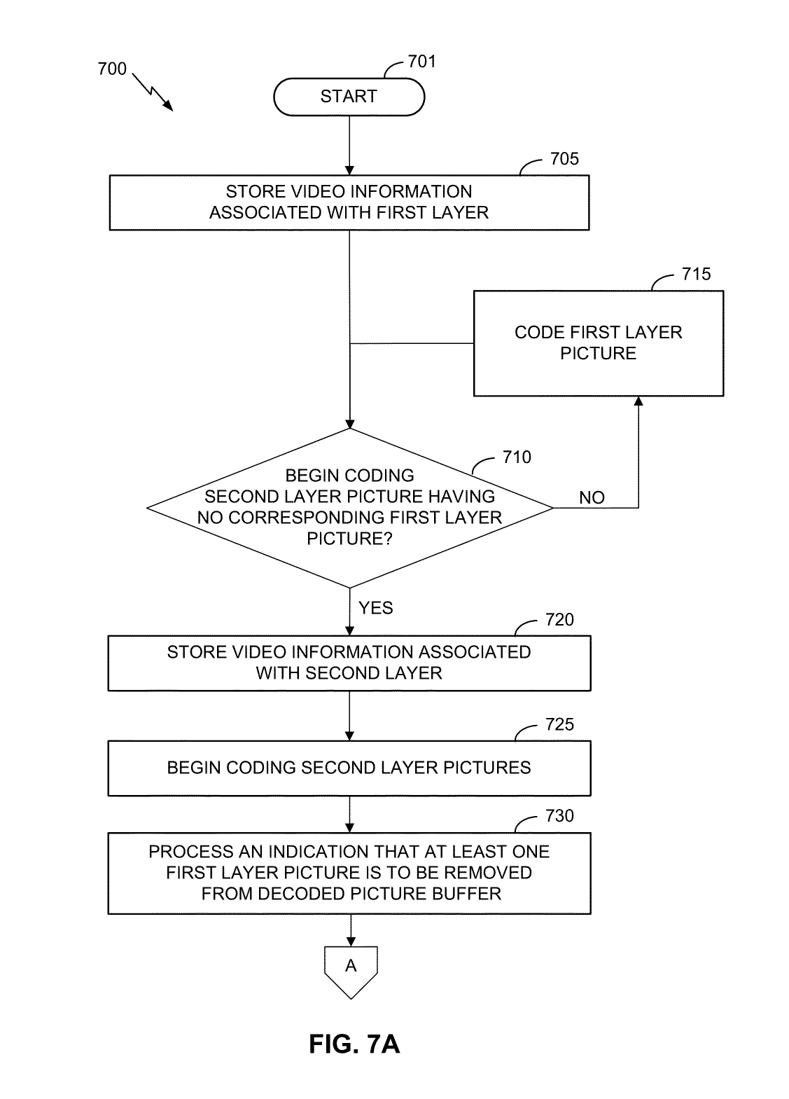

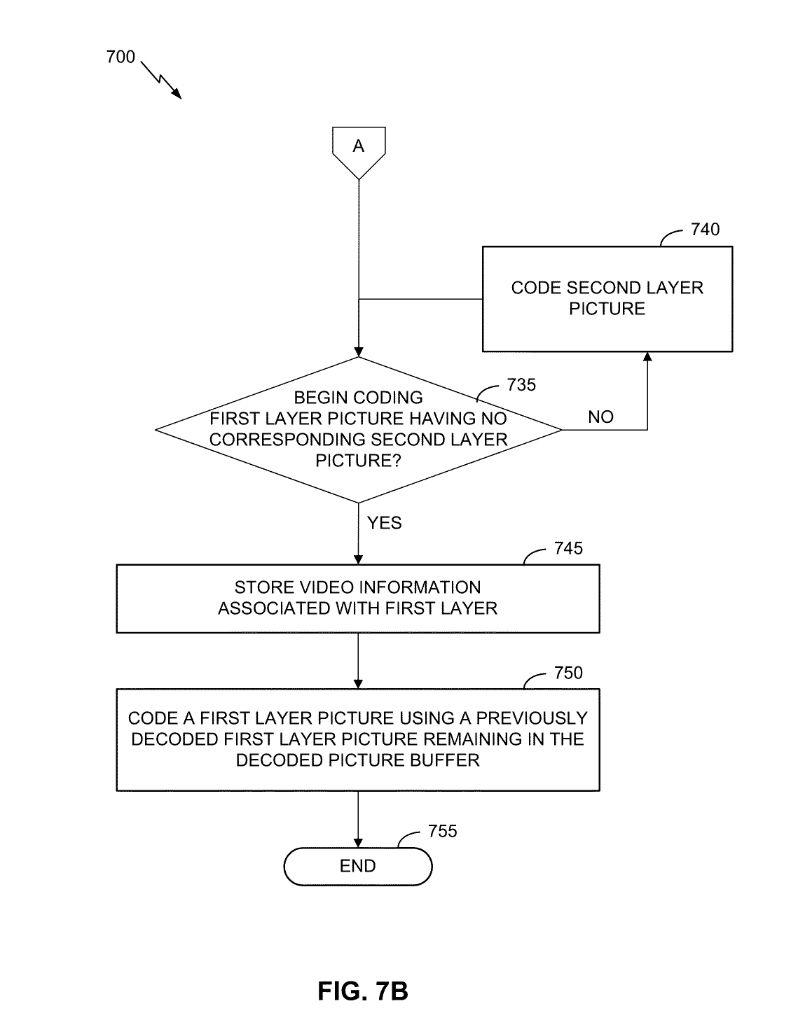

As further discussed below with reference to FIGS. 7A and 7B, the prediction processing unit 100 may be configured to code (e.g., encode or decode) the PU (or any other reference layer and/or enhancement layer blocks or video units) by performing the methods illustrated in FIGS. 7A and 7B. For example, inter prediction unit 121 (e.g., via motion estimation unit 122 and/or motion compensation unit 124), intra prediction unit 126, or inter-layer prediction unit 128 may be configured to perform the methods illustrated in FIGS. 7A and 7B, either together or separately.

As part of performing an encoding operation on a CU, intra prediction unit 126 may perform intra prediction on PUs of the CU. Intra prediction may provide spatial compression. When intra prediction unit 126 performs intra prediction on a PU, intra prediction unit 126 may generate prediction data for the PU based on decoded samples of other PUs in the same picture. The prediction data for the PU may include a predicted video block and various syntax elements. Intra prediction unit 126 may perform intra prediction on PUs in I slices, P slices, and B slices.

To perform intra prediction on a PU, intra prediction unit 126 may use multiple intra prediction modes to generate multiple sets of prediction data for the PU. When intra prediction unit 126 uses an intra prediction mode to generate a set of prediction data for the PU, intra prediction unit 126 may extend samples from video blocks of neighboring PUs across the video block of the PU in a direction and/or gradient associated with the intra prediction mode. The neighboring PUs may be above, above and to the right, above and to the left, or to the left of the PU, assuming a left-to-right, top-to-bottom encoding order for PUs, CUs, and treeblocks. Intra prediction unit 126 may use various numbers of intra prediction modes, e.g., 33 directional intra prediction modes, depending on the size of the PU.

Prediction processing unit 100 may select the prediction data for a PU from among the prediction data generated by motion compensation unit 124 for the PU or the prediction data generated by intra prediction unit 126 for the PU. In some examples, prediction processing unit 100 selects the prediction data for the PU based on rate/distortion metrics of the sets of prediction data.

If prediction processing unit 100 selects prediction data generated by intra prediction unit 126, prediction processing unit 100 may signal the intra prediction mode that was used to generate the prediction data for the PUs, e.g., the selected intra prediction mode. Prediction processing unit 100 may signal the selected intra prediction mode in various ways. For example, it is probable the selected intra prediction mode is the same as the intra prediction mode of a neighboring PU. In other words, the intra prediction mode of the neighboring PU may be the most probable mode for the current PU. Thus, prediction processing unit 100 may generate a syntax element to indicate that the selected intra prediction mode is the same as the intra prediction mode of the neighboring PU.

As discussed above, the video encoder 20 may include inter-layer prediction unit 128. Inter-layer prediction unit 128 is configured to predict a current block (e.g., a current block in the EL) using one or more different layers that are available in SVC (e.g., a base or reference layer). Such prediction may be referred to as inter-layer prediction. Inter-layer prediction unit 128 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

After prediction processing unit 100 selects the prediction data for PUs of a CU, residual generation unit 102 may generate residual data for the CU by subtracting (e.g., indicated by the minus sign) the predicted video blocks of the PUs of the CU from the video block of the CU. The residual data of a CU may include 2D residual video blocks that correspond to different sample components of the samples in the video block of the CU. For example, the residual data may include a residual video block that corresponds to differences between luminance components of samples in the predicted video blocks of the PUs of the CU and luminance components of samples in the original video block of the CU. In addition, the residual data of the CU may include residual video blocks that correspond to the differences between chrominance components of samples in the predicted video blocks of the PUs of the CU and the chrominance components of the samples in the original video block of the CU.

Prediction processing unit 100 may perform quadtree partitioning to partition the residual video blocks of a CU into sub-blocks. Each undivided residual video block may be associated with a different TU of the CU. The sizes and positions of the residual video blocks associated with TUs of a CU may or may not be based on the sizes and positions of video blocks associated with the PUs of the CU. A quadtree structure known as a “residual quad tree” (RQT) may include nodes associated with each of the residual video blocks. The TUs of a CU may correspond to leaf nodes of the RQT.

Transform processing unit 104 may generate one or more transform coefficient blocks for each TU of a CU by applying one or more transforms to a residual video block associated with the TU. Each of the transform coefficient blocks may be a 2D matrix of transform coefficients. Transform processing unit 104 may apply various transforms to the residual video block associated with a TU. For example, transform processing unit 104 may apply a discrete cosine transform (DCT), a directional transform, or a conceptually similar transform to the residual video block associated with a TU.

After transform processing unit 104 generates a transform coefficient block associated with a TU, quantization unit 106 may quantize the transform coefficients in the transform coefficient block. Quantization unit 106 may quantize a transform coefficient block associated with a TU of a CU based on a QP value associated with the CU.

Video encoder 20 may associate a QP value with a CU in various ways. For example, video encoder 20 may perform a rate-distortion analysis on a treeblock associated with the CU. In the rate-distortion analysis, video encoder 20 may generate multiple coded representations of the treeblock by performing an encoding operation multiple times on the treeblock. Video encoder 20 may associate different QP values with the CU when video encoder 20 generates different encoded representations of the treeblock. Video encoder 20 may signal that a given QP value is associated with the CU when the given QP value is associated with the CU in a coded representation of the treeblock that has a lowest bitrate and distortion metric.

Inverse quantization unit 108 and inverse transform unit 110 may apply inverse quantization and inverse transforms to the transform coefficient block, respectively, to reconstruct a residual video block from the transform coefficient block. Reconstruction unit 112 may add the reconstructed residual video block to corresponding samples from one or more predicted video blocks generated by prediction processing unit 100 to produce a reconstructed video block associated with a TU. By reconstructing video blocks for each TU of a CU in this way, video encoder 20 may reconstruct the video block of the CU.

After reconstruction unit 112 reconstructs the video block of a CU, filter unit 113 may perform a deblocking operation to reduce blocking artifacts in the video block associated with the CU. After performing the one or more deblocking operations, filter unit 113 may store the reconstructed video block of the CU in decoded picture buffer 114. Motion estimation unit 122 and motion compensation unit 124 may use a reference picture that contains the reconstructed video block to perform inter prediction on PUs of subsequent pictures. In addition, intra prediction unit 126 may use reconstructed video blocks in decoded picture buffer 114 to perform intra prediction on other PUs in the same picture as the CU.

Entropy encoding unit 116 may receive data from other functional components of video encoder 20. For example, entropy encoding unit 116 may receive transform coefficient blocks from quantization unit 106 and may receive syntax elements from prediction processing unit 100. When entropy encoding unit 116 receives the data, entropy encoding unit 116 may perform one or more entropy encoding operations to generate entropy encoded data. For example, video encoder 20 may perform a context adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding unit 116 may output a bitstream that includes the entropy encoded data.

As part of performing an entropy encoding operation on data, entropy encoding unit 116 may select a context model. If entropy encoding unit 116 is performing a CABAC operation, the context model may indicate estimates of probabilities of particular bins having particular values. In the context of CABAC, the term “bin” is used to refer to a bit of a binarized version of a syntax element.

### Multi-Layer Video Encoder

FIG. 2B is a block diagram illustrating an example of a multi-layer video encoder 21 that may implement techniques in accordance with aspects described in this disclosure. The video encoder 21 may be configured to process multi-layer video frames, such as for SHVC and multiview coding. Further, the video encoder 21 may be configured to perform any or all of the techniques of this disclosure.

The video encoder 21 includes a video encoder 20A and video encoder 20B, each of which may be configured as the video encoder 20 and may perform the functions described above with respect to the video encoder 20. Further, as indicated by the reuse of reference numbers, the video encoders 20A and 20B may include at least some of the systems and subsystems as the video encoder 20. Although the video encoder 21 is illustrated as including two video encoders 20A and 20B, the video encoder 21 is not limited as such and may include any number of video encoder 20 layers. In some embodiments, the video encoder 21 may include a video encoder 20 for each picture or frame in an access unit. For example, an access unit that includes five pictures may be processed or encoded by a video encoder that includes five encoder layers. In some embodiments, the video encoder 21 may include more encoder layers than frames in an access unit. In some such cases, some of the video encoder layers may be inactive when processing some access units.

In addition to the video encoders 20A and 20B, the video encoder 21 may include an resampling unit 90. The resampling unit 90 may, in some cases, upsample a base layer of a received video frame to, for example, create an enhancement layer. The resampling unit 90 may upsample particular information associated with the received base layer of a frame, but not other information. For example, the resampling unit 90 may upsample the spatial size or number of pixels of the base layer, but the number of slices or the picture order count may remain constant. In some cases, the resampling unit 90 may not process the received video and/or may be optional. For example, in some cases, the prediction processing unit 100 may perform upsampling. In some embodiments, the resampling unit 90 is configured to upsample a layer and reorganize, redefine, modify, or adjust one or more slices to comply with a set of slice boundary rules and/or raster scan rules. Although primarily described as upsampling a base layer, or a lower layer in an access unit, in some cases, the resampling unit 90 may downsample a layer. For example, if during streaming of a video bandwidth is reduced, a frame may be downsampled instead of upsampled.

The resampling unit 90 may be configured to receive a picture or frame (or picture information associated with the picture) from the decoded picture buffer 114 of the lower layer encoder (e.g., the video encoder 20A) and to upsample the picture (or the received picture information). This upsampled picture may then be provided to the prediction processing unit 100 of a higher layer encoder (e.g., the video encoder 20B) configured to encode a picture in the same access unit as the lower layer encoder. In some cases, the higher layer encoder is one layer removed from the lower layer encoder. In other cases, there may be one or more higher layer encoders between the layer 0 video encoder and the layer 1 encoder of FIG. 2B.

In some cases, the resampling unit 90 may be omitted or bypassed. In such cases, the picture from the decoded picture buffer 114 of the video encoder 20A may be provided directly, or at least without being provided to the resampling unit 90, to the prediction processing unit 100 of the video encoder 20B. For example, if video data provided to the video encoder 20B and the reference picture from the decoded picture buffer 114 of the video encoder 20A are of the same size or resolution, the reference picture may be provided to the video encoder 20B without any resampling.

In some embodiments, the video encoder 21 downsamples video data to be provided to the lower layer encoder using the downsampling unit 94 before provided the video data to the video encoder 20A. Alternatively, the downsampling unit 94 may be a resampling unit 90 capable of upsampling or downsampling the video data. In yet other embodiments, the downsampling unit 94 may be omitted.

As illustrated in FIG. 2B, the video encoder 21 may further include a multiplexor 98, or mux. The mux 98 can output a combined bitstream from the video encoder 21. The combined bitstream may be created by taking a bitstream from each of the video encoders 20A and 20B and alternating which bitstream is output at a given time. While in some cases the bits from the two (or more in the case of more than two video encoder layers) bitstreams may be alternated one bit at a time, in many cases the bitstreams are combined differently. For example, the output bitstream may be created by alternating the selected bitstream one block at a time. In another example, the output bitstream may be created by outputting a non-1:1 ratio of blocks from each of the video encoders 20A and 20B. For instance, two blocks may be output from the video encoder 20B for each block output from the video encoder 20A. In some embodiments, the output stream from the mux 98 may be preprogrammed. In other embodiments, the mux 98 may combine the bitstreams from the video encoders 20A, 20B based on a control signal received from a system external to the video encoder 21, such as from a processor on a source device including the source module 12. The control signal may be generated based on the resolution or bitrate of a video from the video source 18, based on a bandwidth of the link 16, based on a subscription associated with a user (e.g., a paid subscription versus a free subscription), or based on any other factor for determining a resolution output desired from the video encoder 21.

### Video Decoder

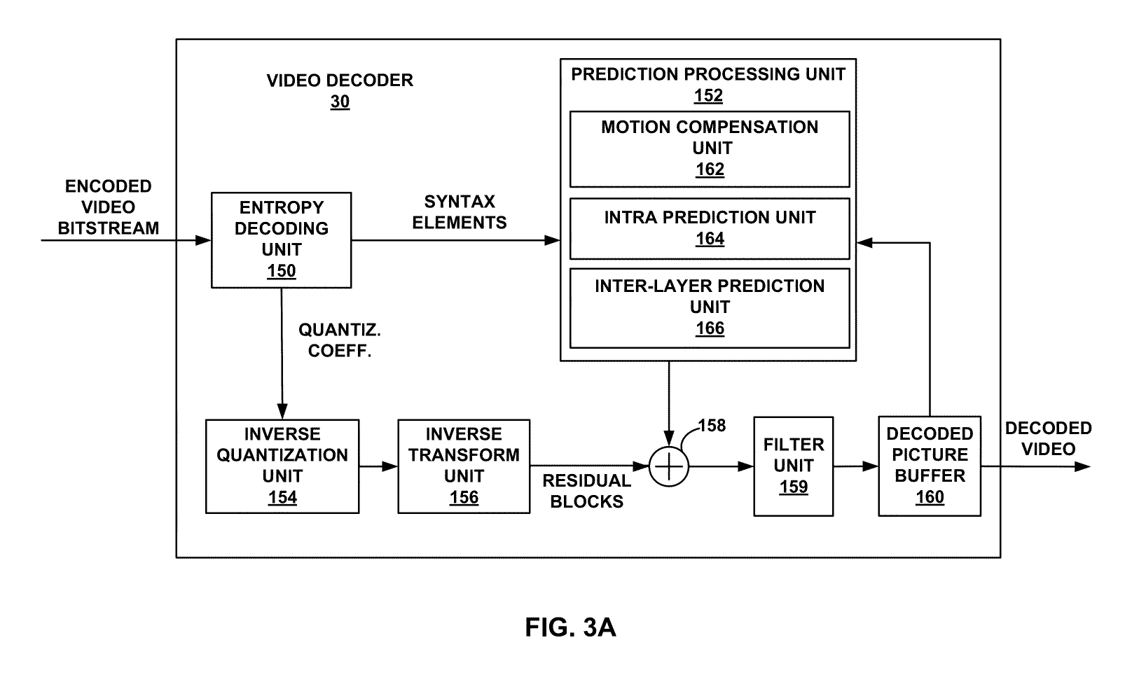

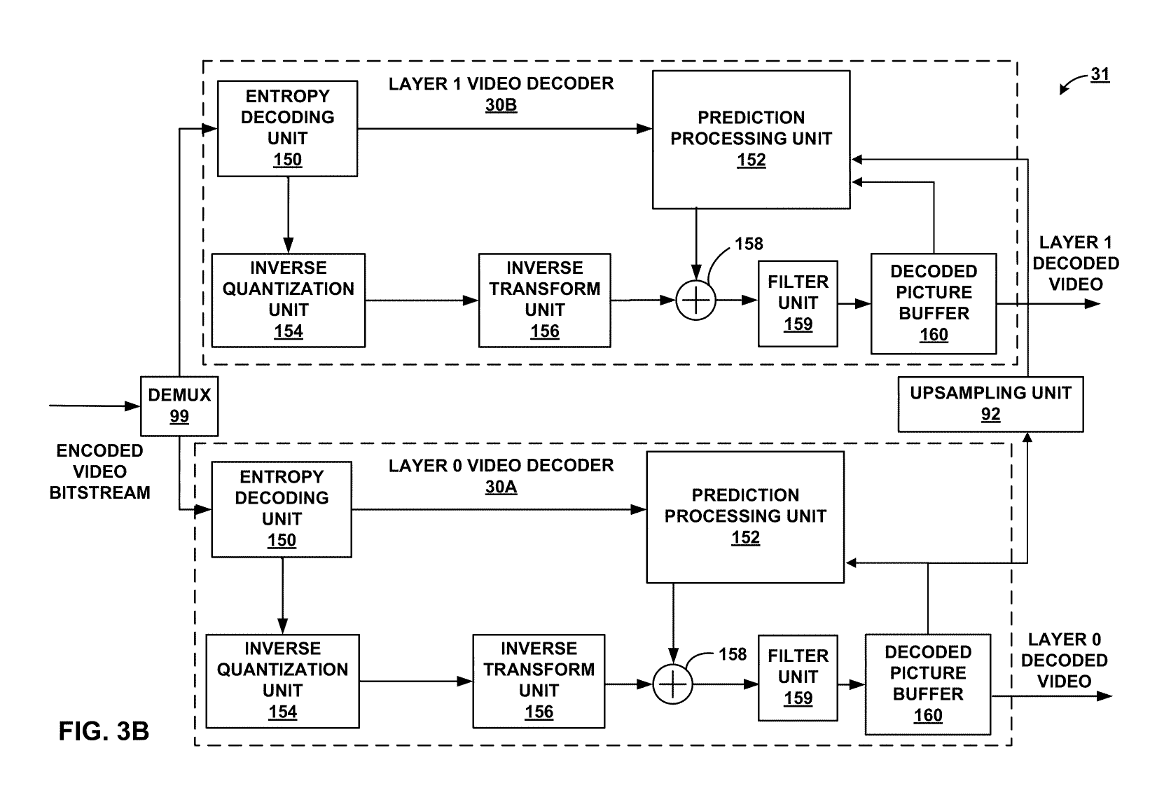

FIG. 3A is a block diagram illustrating an example of a video decoder that may implement techniques in accordance with aspects described in this disclosure. The video decoder 30 may be configured to process a single layer of a video frame, such as for HEVC. Further, video decoder 30 may be configured to perform any or all of the techniques of this disclosure. As one example, motion compensation unit 162 and/or intra prediction unit 164 may be configured to perform any or all of the techniques described in this disclosure. In one embodiment, video decoder 30 may optionally include inter-layer prediction unit 166 that is configured to perform any or all of the techniques described in this disclosure. In other embodiments, inter-layer prediction can be performed by prediction processing unit 152 (e.g., motion compensation unit 162 and/or intra prediction unit 164), in which case the inter-layer prediction unit 166 may be omitted. However, aspects of this disclosure are not so limited. In some examples, the techniques described in this disclosure may be shared among the various components of video decoder 30. In some examples, additionally or alternatively, a processor (not shown) may be configured to perform any or all of the techniques described in this disclosure.

For purposes of explanation, this disclosure describes video decoder 30 in the context of HEVC coding. However, the techniques of this disclosure may be applicable to other coding standards or methods. The example depicted in FIG. 3A is for a single layer codec. However, as will be described further with respect to FIG. 3B, some or all of the video decoder 30 may be duplicated for processing of a multi-layer codec.

In the example of FIG. 3A, video decoder 30 includes a plurality of functional components. The functional components of video decoder 30 include an entropy decoding unit 150, a prediction processing unit 152, an inverse quantization unit 154, an inverse transform unit 156, a reconstruction unit 158, a filter unit 159, and a decoded picture buffer 160. Prediction processing unit 152 includes a motion compensation unit 162, an intra prediction unit 164, and an inter-layer prediction unit 166. In some examples, video decoder 30 may perform a decoding pass generally reciprocal to the encoding pass described with respect to video encoder 20 of FIG. 2A. In other examples, video decoder 30 may include more, fewer, or different functional components.

Video decoder 30 may receive a bitstream that comprises encoded video data. The bitstream may include a plurality of syntax elements. When video decoder 30 receives the bitstream, entropy decoding unit 150 may perform a parsing operation on the bitstream. As a result of performing the parsing operation on the bitstream, entropy decoding unit 150 may extract syntax elements from the bitstream. As part of performing the parsing operation, entropy decoding unit 150 may entropy decode entropy encoded syntax elements in the bitstream. Prediction processing unit 152, inverse quantization unit 154, inverse transform unit 156, reconstruction unit 158, and filter unit 159 may perform a reconstruction operation that generates decoded video data based on the syntax elements extracted from the bitstream.

As discussed above, the bitstream may comprise a series of NAL units. The NAL units of the bitstream may include video parameter set NAL units, sequence parameter set NAL units, picture parameter set NAL units, SEI NAL units, and so on. As part of performing the parsing operation on the bitstream, entropy decoding unit 150 may perform parsing operations that extract and entropy decode sequence parameter sets from sequence parameter set NAL units, picture parameter sets from picture parameter set NAL units, SEI data from SEI NAL units, and so on.

In addition, the NAL units of the bitstream may include coded slice NAL units. As part of performing the parsing operation on the bitstream, entropy decoding unit 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding unit 150 may perform entropy decoding operations, such as CABAC decoding operations, on syntax elements in the coded slice header to recover the slice header.

As part of extracting the slice data from coded slice NAL units, entropy decoding unit 150 may perform parsing operations that extract syntax elements from coded CUs in the slice data. The extracted syntax elements may include syntax elements associated with transform coefficient blocks. Entropy decoding unit 150 may then perform CABAC decoding operations on some of the syntax elements.

After entropy decoding unit 150 performs a parsing operation on a non-partitioned CU, video decoder 30 may perform a reconstruction operation on the non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct a residual video block associated with the CU.

As part of performing a reconstruction operation on a TU, inverse quantization unit 154 may inverse quantize, e.g., de-quantize, a transform coefficient block associated with the TU. Inverse quantization unit 154 may inverse quantize the transform coefficient block in a manner similar to the inverse quantization processes proposed for HEVC or defined by the H.264 decoding standard. Inverse quantization unit 154 may use a quantization parameter QP calculated by video encoder 20 for a CU of the transform coefficient block to determine a degree of quantization and, likewise, a degree of inverse quantization for inverse quantization unit 154 to apply.

After inverse quantization unit 154 inverse quantizes a transform coefficient block, inverse transform unit 156 may generate a residual video block for the TU associated with the transform coefficient block. Inverse transform unit 156 may apply an inverse transform to the transform coefficient block in order to generate the residual video block for the TU. For example, inverse transform unit 156 may apply an inverse DCT, an inverse integer transform, an inverse Karhunen-Loeve transform (KLT), an inverse rotational transform, an inverse directional transform, or another inverse transform to the transform coefficient block. In some examples, inverse transform unit 156 may determine an inverse transform to apply to the transform coefficient block based on signaling from video encoder 20. In such examples, inverse transform unit 156 may determine the inverse transform based on a signaled transform at the root node of a quadtree for a treeblock associated with the transform coefficient block. In other examples, inverse transform unit 156 may infer the inverse transform from one or more coding characteristics, such as block size, coding mode, or the like. In some examples, inverse transform unit 156 may apply a cascaded inverse transform.

In some examples, motion compensation unit 162 may refine the predicted video block of a PU by performing interpolation based on interpolation filters. Identifiers for interpolation filters to be used for motion compensation with sub-sample precision may be included in the syntax elements. Motion compensation unit 162 may use the same interpolation filters used by video encoder 20 during generation of the predicted video block of the PU to calculate interpolated values for sub-integer samples of a reference block. Motion compensation unit 162 may determine the interpolation filters used by video encoder 20 according to received syntax information and use the interpolation filters to produce the predicted video block.

As further discussed below with reference to FIGS. 7A and 7B, the prediction processing unit 152 may code (e.g., encode or decode) the PU (or any other reference layer and/or enhancement layer blocks or video units) by performing the methods illustrated in FIGS. 7A and 7B. For example, motion compensation unit 162, intra prediction unit 164, or inter-layer prediction unit 166 may be configured to perform the methods illustrated in FIGS. 7A and 7B, either together or separately.

If a PU is encoded using intra prediction, intra prediction unit 164 may perform intra prediction to generate a predicted video block for the PU. For example, intra prediction unit 164 may determine an intra prediction mode for the PU based on syntax elements in the bitstream. The bitstream may include syntax elements that intra prediction unit 164 may use to determine the intra prediction mode of the PU.

In some instances, the syntax elements may indicate that intra prediction unit 164 is to use the intra prediction mode of another PU to determine the intra prediction mode of the current PU. For example, it may be probable that the intra prediction mode of the current PU is the same as the intra prediction mode of a neighboring PU. In other words, the intra prediction mode of the neighboring PU may be the most probable mode for the current PU. Hence, in this example, the bitstream may include a small syntax element that indicates that the intra prediction mode of the PU is the same as the intra prediction mode of the neighboring PU. Intra prediction unit 164 may then use the intra prediction mode to generate prediction data (e.g., predicted samples) for the PU based on the video blocks of spatially neighboring PUs.

As discussed above, video decoder 30 may also include inter-layer prediction unit 166. Inter-layer prediction unit 166 is configured to predict a current block (e.g., a current block in the EL) using one or more different layers that are available in SVC (e.g., a base or reference layer). Such prediction may be referred to as inter-layer prediction. Inter-layer prediction unit 166 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

Reconstruction unit 158 may use the residual video blocks associated with TUs of a CU and the predicted video blocks of the PUs of the CU, e.g., either intra-prediction data or inter-prediction data, as applicable, to reconstruct the video block of the CU. Thus, video decoder 30 may generate a predicted video block and a residual video block based on syntax elements in the bitstream and may generate a video block based on the predicted video block and the residual video block.

After reconstruction unit 158 reconstructs the video block of the CU, filter unit 159 may perform a deblocking operation to reduce blocking artifacts associated with the CU. After filter unit 159 performs a deblocking operation to reduce blocking artifacts associated with the CU, video decoder 30 may store the video block of the CU in decoded picture buffer 160. Decoded picture buffer 160 may provide reference pictures for subsequent motion compensation, intra prediction, and presentation on a display device, such as display device 32 of FIG. 1A or 1B. For instance, video decoder 30 may perform, based on the video blocks in decoded picture buffer 160, intra prediction or inter prediction operations on PUs of other CUs.

### Multi-Layer Decoder

FIG. 3B is a block diagram illustrating an example of a multi-layer video decoder 31 that may implement techniques in accordance with aspects described in this disclosure. The video decoder 31 may be configured to process multi-layer video frames, such as for SHVC and multiview coding. Further, the video decoder 31 may be configured to perform any or all of the techniques of this disclosure.

The video decoder 31 includes a video decoder 30A and video decoder 30B, each of which may be configured as the video decoder 30 and may perform the functions described above with respect to the video decoder 30. Further, as indicated by the reuse of reference numbers, the video decoders 30A and 30B may include at least some of the systems and subsystems as the video decoder 30. Although the video decoder 31 is illustrated as including two video decoders 30A and 30B, the video decoder 31 is not limited as such and may include any number of video decoder 30 layers. In some embodiments, the video decoder 31 may include a video decoder 30 for each picture or frame in an access unit. For example, an access unit that includes five pictures may be processed or decoded by a video decoder that includes five decoder layers. In some embodiments, the video decoder 31 may include more decoder layers than frames in an access unit. In some such cases, some of the video decoder layers may be inactive when processing some access units.

In addition to the video decoders 30A and 30B, the video decoder 31 may include an upsampling unit 92. In some embodiments, the upsampling unit 92 may upsample a base layer of a received video frame to create an enhanced layer to be added to the reference picture list for the frame or access unit. This enhanced layer can be stored in the decoded picture buffer 160. In some embodiments, the upsampling unit 92 can include some or all of the embodiments described with respect to the resampling unit 90 of FIG. 2A. In some embodiments, the upsampling unit 92 is configured to upsample a layer and reorganize, redefine, modify, or adjust one or more slices to comply with a set of slice boundary rules and/or raster scan rules. In some cases, the upsampling unit 92 may be a resampling unit configured to upsample and/or downsample a layer of a received video frame

The upsampling unit 92 may be configured to receive a picture or frame (or picture information associated with the picture) from the decoded picture buffer 160 of the lower layer decoder (e.g., the video decoder 30A) and to upsample the picture (or the received picture information). This upsampled picture may then be provided to the prediction processing unit 152 of a higher layer decoder (e.g., the video decoder 30B) configured to decode a picture in the same access unit as the lower layer decoder. In some cases, the higher layer decoder is one layer removed from the lower layer decoder. In other cases, there may be one or more higher layer decoders between the layer 0 decoder and the layer 1 decoder of FIG. 3B.

In some cases, the upsampling unit 92 may be omitted or bypassed. In such cases, the picture from the decoded picture buffer 160 of the video decoder 30A may be provided directly, or at least without being provided to the upsampling unit 92, to the prediction processing unit 152 of the video decoder 30B. For example, if video data provided to the video decoder 30B and the reference picture from the decoded picture buffer 160 of the video decoder 30A are of the same size or resolution, the reference picture may be provided to the video decoder 30B without upsampling. Further, in some embodiments, the upsampling unit 92 may be a resampling unit 90 configured to upsample or downsample a reference picture received from the decoded picture buffer 160 of the video decoder 30A.

As illustrated in FIG. 3B, the video decoder 31 may further include a demultiplexor 99, or demux. The demux 99 can split an encoded video bitstream into multiple bitstreams with each bitstream output by the demux 99 being provided to a different video decoder 30A and 30B. The multiple bitstreams may be created by receiving a bitstream and each of the video decoders 30A and 30B receives a portion of the bitstream at a given time. While in some cases the bits from the bitstream received at the demux 99 may be alternated one bit at a time between each of the video decoders (e.g., video decoders 30A and 30B in the example of FIG. 3B), in many cases the bitstream is divided differently. For example, the bitstream may be divided by alternating which video decoder receives the bitstream one block at a time. In another example, the bitstream may be divided by a non-1:1 ratio of blocks to each of the video decoders 30A and 30B. For instance, two blocks may be provided to the video decoder 30B for each block provided to the video decoder 30A. In some embodiments, the division of the bitstream by the demux 99 may be preprogrammed. In other embodiments, the demux 99 may divide the bitstream based on a control signal received from a system external to the video decoder 31, such as from a processor on a destination device including the destination module 14. The control signal may be generated based on the resolution or bitrate of a video from the input interface 28, based on a bandwidth of the link 16, based on a subscription associated with a user (e.g., a paid subscription versus a free subscription), or based on any other factor for determining a resolution obtainable by the video decoder 31.

### Resolution Change

In the current HEVC extension draft, a video parameter sequence (VPS) syntax element called single_layer_for_non_irap_flag is defined as follows: “single_layer_for_non_irap_flag equal to 1 indicates either that all the VCL NAL units of an access unit have the same nuh_layer_id value or that two nuh_layer_id values are used by the VCL NAL units of an access unit and the picture with the greater nuh_layer_id value is an TRAP picture. single_layer_for_non_irap_flag equal to 0 indicates that nuh_layer_id values may or may not be constrained beyond constraints specified in other parts of this Recommendation I International Standard.” In some embodiments, the techniques described herein may only apply when the single_layer_for_non_irap_flag is equal to 1.

Generally, coded video data is organized into network abstraction layer (NAL) units, each of which is effectively a packet that contains an integer number of bytes. Video coding layer (VCL) NAL units contain sample values of the video pictures that are in the coded video data. An access unit (AU) is a set of VCL NAL units that are associated with pictures to be displayed at the same time (e.g., pictures having the same picture order count). Thus, for example, if single_layer_for_non_irap_flag is equal to 1, either all the pictures in the access unit are from the same layer (e.g., the current layer), or the pictures belong to two different layers, the picture in the higher layer being an intra random access point (TRAP) picture. If there are two pictures in an access unit, one from the reference or lower layer and the other from the enhancement layer, the enhancement layer picture, being from the higher layer, would be the TRAP picture. In one example, the enhancement layer picture has a higher resolution that the reference layer picture. Thus, this flag (or other similar flags) can be used to signal or identify a switch from one layer to another layer.

### Application of Resolution Change

Such a switch may be accompanied by a resolution change (e.g., from a lower resolution to a higher resolution, or from a higher resolution to a lower resolution). As discussed above, one application for such a resolution change may be in the context of video applications that process video data (e.g., video conferencing application, movie streaming application, etc.). When a video application processes a video stream, the video application may switch between a lower resolution mode (e.g., in which lower resolution pictures are processed and displayed) and a higher resolution mode (e.g., in which higher resolution pictures are processed and displayed) depending on bandwidth conditions. If the bandwidth initially cannot support higher resolution streaming, the application may process the video stream in the lower resolution mode, and when the bandwidth improves, the application may switch to the higher resolution mode so that it can display a higher quality video.

In one embodiment, the resolution change can be initiated by the video application. Alternatively, the user may decide to initiate the resolution change. A resolution change may occur automatically based on other factors, such as bandwidth conditions. In some embodiments, there is a delay between the time the resolution change is requested or initiated, and the time the coder actually switches to coding pictures having a different resolution. In one example, the coder knows in advance that there is going to be a resolution change and/or when the resolution change is going to occur.

### Switching to a Different Layer

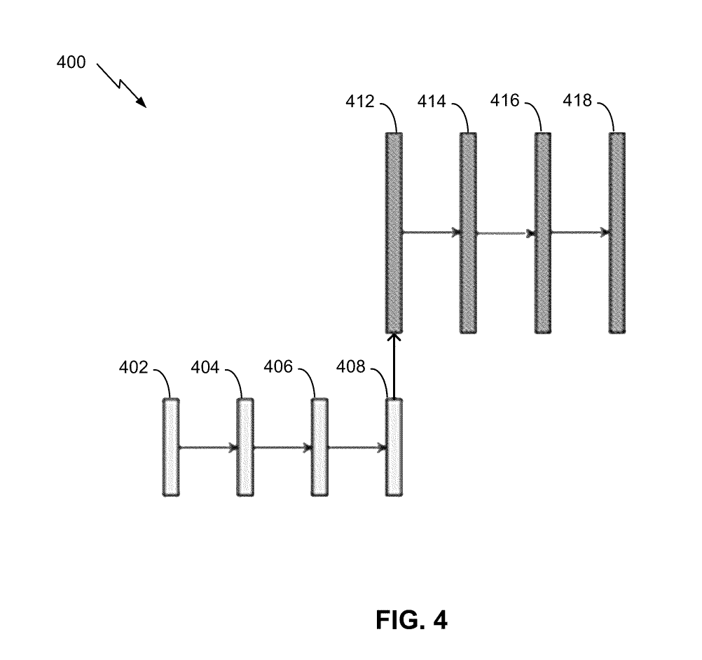

A resolution change does not necessarily mean that more than one video layer is involved. For example, HEVC allows resolution changes within a single layer. However, in such a case, upon changing the resolution of the pictures, a new CVS is started, and the coder (e.g., encoder or decoder) will start from an I-frame. Thus, the coder will not be able to rely on any previously coded pictures to improve coding efficiency. By switching to a different layer when there is a resolution change, the coder may still have access to previously decoded pictures of the lower layer and possibly use inter-layer prediction to code at least one of the pictures in the higher layer, thereby improving coding efficiency. Also, by refraining from coding other pictures that are not to be displayed (e.g., by coding the entire base layer and the entire enhancement layer), coding efficiency is also improved. The switch from a lower layer to a higher layer is further described with reference to FIG. 4.

FIG. 4 shows base layer pictures 402, 404, 406, and 408, and enhancement layer pictures 412, 414, 416, and 418. In this example, the arrows indicate the decoding order, which is the same as the display order in this case. For example, of the pictures that are illustrated in FIG. 4, base layer picture 402 is the first picture to be displayed, and the enhancement layer picture 418 is the last picture to be displayed. At the switching point, where the arrow points upward from base layer picture 408 to enhancement layer picture 412, only one of the two pictures are displayed because the pictures belong to the same access unit and thus correspond to the same time. For example, only enhancement layer picture 412 is displayed, and base layer picture 408 is not displayed. Although the decoding order is the same as the display order in the example of FIG. 4, in another embodiment, the decoding order may be different from the display order.

As illustrated in FIG. 4, the base layer pictures and the enhancement layer pictures belong to different layers. Base layer pictures 402-408 may be coded using other previously coded base layer pictures, and enhancement layer pictures 412-418 may be coded using other previously coded enhancement layer pictures. Further, enhancement layer picture 412 may be coded using base layer picture 408 (e.g., using inter-layer prediction). In one embodiment, enhancement layer pictures 412-418 have a resolution that is higher than the resolution of the base layer pictures 402-408.

### Decoded Picture Buffer (DPB)

Generally, pictures that have been coded can be stored in a decoded picture buffer (DPB) so that they can be used to code other pictures. For example, a video coder may use pixel values or other information (e.g., motion information) of previously coded pictures in the DPB to code subsequent pictures. However, the DPB has limited space, and not all coded pictures can be stored in the DPB and continue to remain in the DPB indefinitely. Therefore, timely removing unnecessary pictures from the DPB can improve DPB management and memory usage.

In the example discussed above, a resolution change may occur when the application (or the user of the application) decides to switch to a higher resolution mode (or a lower resolution mode). When the application switches to a higher resolution mode, the application will start coding pictures of a higher layer (e.g., enhancement layer) that have a higher resolution than the pictures of the lower layer, which were coded before the resolution change. Upon switching to the higher resolution, the reference pictures of the previous lower layer (e.g., the reference layer, which has pictures having a lower resolution) may still be stored in the decoded picture buffer (DPB). However, such reference pictures may no longer be necessary for decoding the bitstream, since, the pictures that are coded after the switch are in the higher layer (e.g., enhancement layer). In one example, one or more of such reference pictures may be used to code future lower layer pictures if the application decides to switch back down to the lower layer. However, if the application stays in the higher resolution mode or switches to a layer other than the lower layer, there may not be any reason to keep any of those reference pictures of the lower layer in the DPB. Thus, a mechanism for removing the reference pictures of the previous lower layer from the DPB may be desired to improve memory usage.

Also, in some implementations, even if the application decides to switch back to the lower resolution mode, a new layer ID may be assigned to the new layer even if the application is merely switching back to the original lower resolution of the lower layer. In such a case, because the new layer is assigned a new layer ID, even if one or more reference pictures having the same resolution as the pictures of the new layer are kept in the DPB, those reference pictures cannot be used to inter predict the pictures of the new layer. Thus, in order to improve coding efficiency, it may be desirable to prevent the use of a new layer ID when the application is merely switching back down (or up) to the previous resolution.

Further, in some implementations, when single_layer_for_non_irap_flag is equal to 1, the application is allowed to switch between layers without changing the resolution, color format, or bit depth. However, in such a case, it may be more efficient to stay in the same layer without switching to a new layer.

Removing Lower Layer Pictures from Decoded Picture Buffer

When a resolution switching is performed (e.g., as illustrated in FIG. 4), there are pictures from up to two different layers at the switching point: a lower layer (e.g., associated with a smaller value of nuh_layer_id) and a higher layer (e.g., associated with a greater value of nuh_layer_id). There may be more pictures/layers involved if the switching is performed (e.g., up or down) more than once. For example, the application can switch from layer 1 to layer 2 in one access unit, later from layer 2 to layer 3, in the another access unit. In general, the two layers may be referred to as “switching-from layer” and “switched-to layer”. For example, the lower layer may be referred to as the switching-from layer, and the higher layer may be referred to as the switched-to layer in the up-switching point.

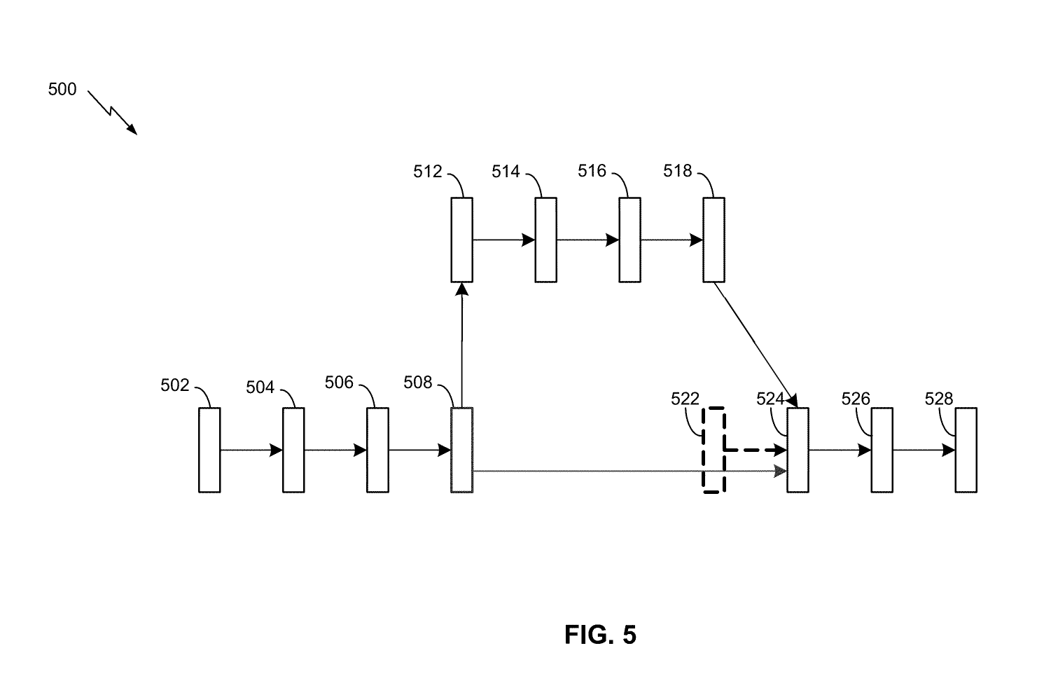

In one example implementation, when switching from a lower layer to a higher layer, the access unit at the switching point (e.g., switching point AU) contains both a picture from the lower layer and a picture from the higher layer. On the other hand, when switching from a higher layer to a lower layer, the switching point AU may have only one picture. For example, the switching may occur over two consecutive access units, each of the consecutive access units containing only one picture. For example, one of the access units may contain a picture from the higher layer, and the subsequent access unit may contain a picture from the lower layer. Such a configuration is further described below with reference to FIG. 5.

In the present disclosure, the embodiments are generally described with reference to an example having one lower layer and one higher layer. However, the embodiments of the present disclosure are not limited to or by such a configuration, and the embodiments, methods, and techniques described herein may be extended to other examples having multiple lower layers and higher layers. Although the examples illustrated herein generally have AUs having at one or two layers, the proposed methods can similarly be extended to other configurations.

When a resolution change takes place, the pictures in the switching-from layer are often no longer needed for inter prediction after the switching point (e.g., after coding the pictures in the AU containing pictures from both layers). In one embodiment, all reference pictures (e.g., previously decoded pictures of the lower layer that are stored in the DPB), including the lower layer picture in the switching point AU, of the switching-from layer stored in the DPB are marked as “unused for reference.” In some implementations, any reference picture that is marked as “unused for reference” is removed from the DPB if it has already been output (e.g., displayed) or if it is not to be output. In this embodiment, all pictures of the switching-from layer that are not to be output or have already been output are removed from the DPB. By removing from the DPB the lower layer pictures that will likely not be used after the switching point, DPB management and memory usage can be improved.

In the example of FIG. 4 in which the resolution switching occurs in the access unit containing base layer picture 408 and enhancement layer picture 412, after decoding base layer picture 408 (e.g., base layer picture at the switching point), previously decoded base layer pictures 402, 404, and 406 that are stored in the DPB may be marked as “unused for reference” as they are no longer necessary for coding base layer pictures (e.g., due to the resolution switching). Further, base layer pictures that are not to be output or have already been output, may be removed from the DPB. After decoding enhancement layer picture 412, (e.g., enhancement layer picture at the switching point), decoded base layer picture 408 stored in the DPB can be removed from the DPB. In another embodiment, any removal of decoded pictures from the DPB is performed after coding enhancement layer picture 412 (e.g., the higher layer picture in the switching point AU). Although the removal of the pictures in the DPB is generally described herein in the context of up-switching, similar DPB management techniques can be applied to down-switching scenarios, in which the picture resolution is reduced.

In one embodiment, a flag may be signaled to indicate whether the DPB should be cleared. For example, if the flag is set to 1, the DPB is cleared after coding the first picture in the higher layer, and if the flag is set to 0, the DPB is not cleared. The flag may be signaled in the slice header.

### Keeping Lower Layer Pictures in the DPB for Future Coding

In one embodiment, instead of marking all the pictures in the DPB as “unused for reference” and/or removing all the pictures in the DPB upon switching to a different layer, at least one picture of the switching-from layer is kept in the DPB for use in future coding. Such pictures kept in the DPB may be referred to as “waiting pictures.” These pictures are caused to remain in the DPB such that if there is a resolution switch back down to the lower resolution, these pictures can be used to code (e.g., using inter prediction) one or more pictures in the lower resolution (e.g., the first picture to be coded after the switch from the higher layer back down to the lower layer).

In one embodiment, every time there is a resolution change, at least one picture of the switching-from layer is kept in the DPB for use in future coding. For example, the picture that is kept in the DPB may be the picture in the switching point AU (e.g., base layer picture 408 of FIG. 4). In another example, the picture that is kept in the DPB may be a picture having a temporal ID of 0. Since a picture having a temporal ID of 0 can be used to code another picture having a temporal of any value, keeping a picture having a temporal ID of 0 may provide flexibility to switch back down or up to the original layer at any time. In one embodiment, only one picture is kept in the DPB and all other pictures are removed upon switching to the different layer. In yet another embodiment, at least one picture is kept in the DPB for each value of temporal ID. For example, the pictures in the lower layer may have temporal ID values 0, 1, and 2. In such a case, at least one lower layer picture having a temporal ID of 0, at least one lower layer picture having a temporal ID of 1, and at least one lower layer picture having a temporal ID of 2 are kept in the DPB. In one example, one picture is kept for each temporal ID, and all other pictures are removed from the DPB upon switching to the different layer.

In one embodiment, pictures that are kept in the DPB are explicitly signaled in the bitstream. For example, the signaling may be similar to the way reference picture sets are signaled. In another embodiment, whether the pictures are to be kept in the DPB may be present in the slice header of the picture of the switched-to layer (e.g., the higher layer picture in the switching point AU), and a flag may be signaled to indicate that a switching takes place in this access unit. The flag may also indicate that there is information in the bitstream indicating whether one or more waiting pictures are to be kept in the DPB. For example, one flag may indicate whether to keep 10 last lower layer pictures in the DPB. For example, there may be a flag that indicates whether the most recently coded lower layer picture is to be kept in the DPB. The number of pictures kept in the DPB may be 1, 2, 3, 10 or any arbitrary number. The number of lower layer pictures to be kept in the DPB may be signaled or known by the coder. A flag may be signaled to indicate whether there will be a switch back to the same layer in the future.

In one embodiment, if the lower layer picture in the switching point AU is the only picture that is kept in the DPB, the lower layer picture is marked as either “used for long-term reference” or “used for short-term reference.” In one embodiment, whether any lower layer pictures are kept in the DPB is indicated in the video parameter set. As discussed above, although one or more example embodiments of the present disclosure are described in the context of switching from a lower layer (e.g., lower resolution layer) to a higher layer (e.g., higher resolution layer), the methods and techniques may be modified and/or extended to the down-switching scenarios in which the resolution is reduced.

In some implementations, although the same mechanisms described in the context of switching from a lower layer to a higher layer can be applied when switching from a higher layer to a lower layer, it may not be necessary to apply the same mechanisms (e.g., keeping higher layer pictures in the DPB so that they can be used in the future coding of higher layer pictures after switching back up to the higher layer), because when switching back to the higher layer at a later time, the picture in the higher layer can be coded based on the lower layer picture in the same AU by utilizing inter-layer prediction, and a higher layer picture from a much earlier time period may be unnecessary or may not be as useful. Another reason that it may not be desirable to keep any EL pictures in the DPB is that there may be a restriction in the switching point AU that the higher layer picture in the switching point AU shall be an TRAP picture. In such a case, the higher layer picture in the switching point AU cannot be predicted using inter prediction from other EL pictures. An example of the proposed mechanism is depicted in FIG. 5.

FIG. 5 illustrates an example that involves a resolution switching from a lower layer to a higher layer, and another resolution switching from the higher layer back down to the lower layer. As shown in FIG. 5, the base layer includes base layer pictures 502, 504, 506, 508, 524, 526, and 528, and the enhancement layer includes enhancement layer pictures 512, 514, 516, and 518. The base layer picture 522 indicated by the dashed line is an imaginary picture that might not be actually signaled or coded. In the example of FIG. 5, when the resolution down-switching occurs, since the enhancement layer picture 518 has already been coded and available to be displayed, there is no reason to code a lower resolution version thereof since it will not be displayed.

In the scenario illustrated in FIG. 5, where the resolution is switched back down to the lower resolution, it may be desirable to keep at least one base layer picture in the DPB prior to the first switching as a temporal reference picture (e.g., base layer picture 508). For example, other base layer pictures (e.g., 502, 504, and 506) can be marked as “unused for reference” as described above. In this case, when the resolution is switched back down to the lower resolution, the base layer picture 508 kept in the DPB can be used for inter prediction of the base layer picture 524, as indicated by the arrow from the base layer picture 508 to the base layer picture 524.

In one embodiment, the picture to be kept in the DPB is not the base layer picture in the switching point AU, but some other base layer picture in the DPB. For example, the picture to be kept in the DPB is the picture that is coded immediately prior to the base layer picture in the switching point AU. In another example, the base layer picture to be kept can be any other picture from the base layer. In another embodiment, multiple pictures can be kept in the DPB upon resolution switching (or simply layer switching without resolution change). In yet another embodiment, the picture that is kept in the DPB is the closest picture with the same temporal ID as the first lower layer picture after switching back to the lower layer (e.g., base layer picture 524 in FIG. 5). For example, if there is an up-switching and a subsequent down-switching, and the first base layer picture after the down-switching has a temporal ID of 1, the picture to be kept in the DPB may be the picture that is temporally closest to the first base layer picture after the down-switching and has a temporal ID of 1. In another embodiment, the picture that is kept in the DPB is the closest picture with a temporal ID of 0. In another embodiment, the picture that is kept in the DPB is the picture that is temporally closest to the first lower layer picture after switching back to the lower layer.

### Dummy Pictures

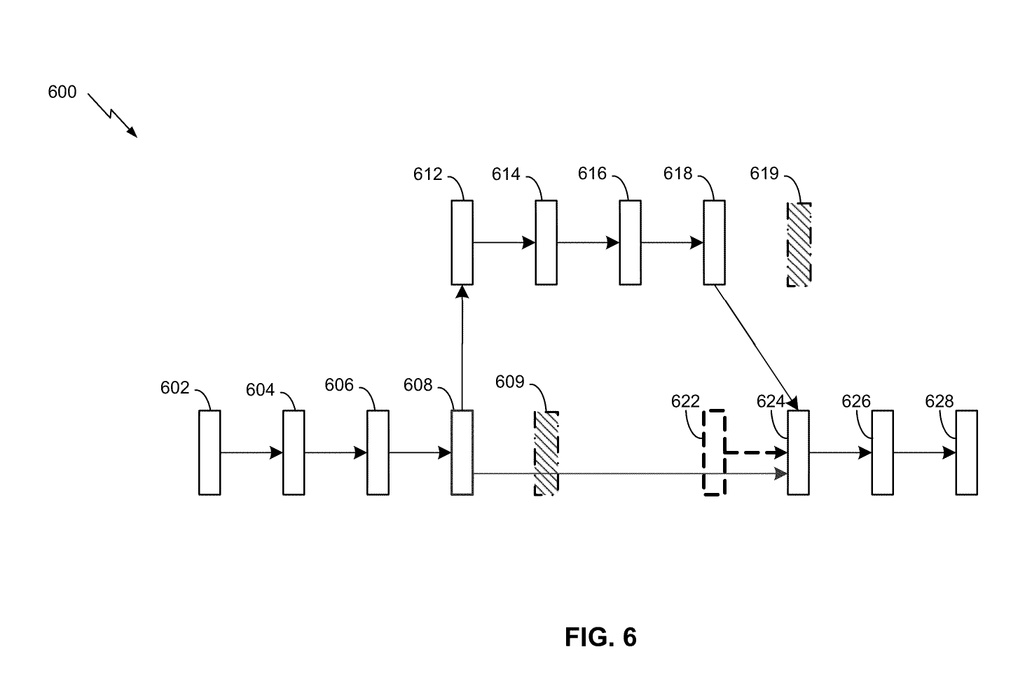

In the case of layer switching (e.g., resolution switching), a dummy picture may be present in the access unit that immediately follows the switching point AU in display order. Example dummy pictures are illustrated in FIG. 6. FIG. 6 shows base layer pictures 602, 604, 606, 608, 624, 626, and 628, enhancement layer pictures 612, 614, 616, and 618, and imaginary picture 622, which is similar to imaginary picture 522 described with reference to FIG. 5. In addition, FIG. 6 includes a dummy picture 609 in the access unit immediately following the switching point AU having base layer picture 608 and enhancement layer picture 612. Also, a dummy picture 619 is present in the access unit immediately following the switching point AU having enhancement layer picture 618. The dummy pictures 609 and 619 may be used to improve reference picture management. For example, the dummy pictures can be used to achieve an earlier reference picture removal from the DPB. For example, the dummy picture 609 may be processed before the enhancement layer picture 612 is coded, and the information included in the dummy picture 609 may indicate that base layer pictures 602, 604, 606 are to be removed from the DPB. In such a case, the base layer pictures 602, 604, and 606 which might have remained in the DPB until after the enhancement layer 612 has finished coding, can be removed from the DPB before the enhancement layer 612 is coded.

In one embodiment, the dummy pictures may mark one or more reference pictures as “unused for reference” or indicate which pictures will be used for future reference and thus should be kept in the DPB. In one implementation, the indication of which pictures in the DPB, if any, should be kept for future reference is present in the reference picture set (RPS) associated with the dummy picture. For example, the RPS of the dummy picture may indicate that one or more of the pictures in the DPB are needed to code the dummy picture. In such a case, those pictures that are indicated as being needed to code the dummy picture would be kept in the DPB. In another implementation, one or more syntax elements or flags associated with the dummy picture may indicate which pictures in the DPB, if any, should be kept for future reference. In one embodiment, the dummy picture may contain one or more syntax elements or flags that indicate that the DPB should be entirely cleared (e.g., none of the pictures should be kept in the DPB).

If the dummy picture is in the same access unit as the picture in the higher layer (e.g., in the case of dummy picture 609 and enhancement layer picture 614), then both pictures are allowed to be non-TRAP pictures. In one embodiment, the semantics of single_layer_for_non_irap_flag may be modified such that this scenario is covered when single_layer_for_non_irap_flag is equal to 1. More specifically, the constraint that the higher layer picture in the switching point AU shall be an TRAP picture can be removed in connection with the dummy picture usage. Alternatively, the constraint that the higher layer picture in the switching point AU shall be an IRAP picture can be removed regardless of the dummy picture usage. Removal of the TRAP constraint provides more flexibility in the higher layer picture coding, allowing the use of inter prediction in addition to the inter-layer prediction.

In one embodiment, the dummy picture may consist of a single VCL NAL unit as specified in HEVC working draft 10. The dummy picture may be coded with inter prediction residual to be equal to 0, and may have pic_output_flag equal to 0 in the slice header (e.g., indicating that the dummy picture is not to be output). Alternatively, the dummy picture may only include the whole slice header syntax. Alternatively, the dummy picture may only include part of the syntax elements in the slice header. For example, the dummy picture may include the syntax elements that identify the POC value of the picture and the reference picture set (RPS). The RPS in the dummy picture may indicate which pictures are to be marked as “unused for reference” and which pictures are to be kept in the DPB (e.g., as waiting pictures) and therefore are marked as “used for short-term reference” or “used for long-term reference” for future reference after switching to a higher layer.

### Switching Back to the Original Layer

In one embodiment, when the application (or the user) switches back to the original layer (e.g., the examples illustrated in FIGS. 5 and 6), the layer ID (e.g., the value of nuh_layer_id) of the original layer is used for the new layer. For example, if the application switches from a lower layer to a higher layer and later decides to switch to another lower layer including pictures of the same resolution as the previous lower layer, the layer ID of the previous lower layer is used for the new lower layer. By forcing the new lower layer to be assigned the same layer ID as the previous lower layer, inter prediction can be used to code pictures in the new lower layer using the pictures of the previous lower layer remaining in the DPB.

In one embodiment, when single_layer_for_non_irap_flag is equal to 1, the greatest value of nuh_layer_id of all VCL NAL units in an AU is maintained to be the same across the AUs in a coded video sequence, unless at least one of the spatial resolution, color format, or bit depth is also changed. By doing so, the application can ensure that layer switching is accompanied by at least one of a resolution change, color format change, or a bit-depth change. In some implementations, unless there is a change in the resolution, color format, or bit-depth, keeping the single-layer approach (e.g., without switching to a different layer) may be desirable for achieving improved coding efficiency and/or computational complexity.

### Example Flowchart

FIG. 7 is a flowchart illustrating a method 700 for coding video information, according to an embodiment of the present disclosure. The steps illustrated in FIG. 7 may be performed by an encoder (e.g., the video encoder as shown in FIG. 2A or FIG. 2B), a decoder (e.g., the video decoder as shown in FIG. 3A or FIG. 3B), or any other component. For convenience, method 700 is described as performed by a coder, which may be the encoder, the decoder, or another component.

The method 700 begins at block 701. In block 705, the coder stores video information associated with a first layer. In block 710, the coder determines whether to begin coding second layer pictures that have no corresponding first layer pictures. For example, the coder may determine that after a certain point in time, only second layer pictures are to be coded, without coding any first layer pictures. In one embodiment, the coder may receive an instruction or a request to begin coding second layer pictures. For example, in the context of video conferencing, the video application may decide, based on bandwidth conditions, to switch to a higher resolution mode so that higher resolution pictures can be displayed to the user. In another example, the user of the video application may elect to switch to a higher resolution mode. Upon receiving such an instruction from the application or the user, the coder may begin coding second layer pictures having a higher resolution. In the absence of such an instruction or if the coder otherwise determines that the coder should continue coding base layer pictures, the coder codes a first layer picture in block 715.

Once the coder determines that the second layer pictures having no corresponding first layer pictures are to be coded, the coder proceeds to block 720 and stores video information associated with the second layer. In one embodiment, the video information associated with the second layer may have already been stored in a memory before the determination in block 710. In such a case, the coder can simply proceed to block 725. The coder begins coding second layer pictures in block 725. In block 730, the coder processes an indication that at least one first layer picture is to be removed from the decoded picture buffer. In one embodiment, the processing comprises marking the at least one first layer picture as unused for reference. In another embodiment, the processing comprises signaling a flag that indicates that the at least one first layer picture is to be removed from the decoded picture buffer. In yet another embodiment, the processing comprises receiving an indication that the at least one first layer picture is to be removed from the decoded picture buffer.

In one embodiment, the coder may actually remove the at least one first layer picture from the DPB. In one embodiment, as described above, the coder may remove all the first layer pictures in the decoded picture buffer. In another embodiment, the coder may decide to keep one or more first layer pictures in the decoded picture buffer for use in future coding and remove the rest of the first layer pictures from the DPB.

As shown in FIG. 7B, in block 735, the coder determines whether to begin coding first layer pictures having no corresponding second layer pictures. As previously discussed, the application or the user may initiate a request or instruction to switch to a lower resolution mode, for example, based on bandwidth conditions. When the user is experiencing a slow internet connection, the user may wish to reduce the resolution of the video that he is currently viewing so that the pictures are displayed more smoothly. In the absence of such an instruction, the coder continues to code second layer pictures in block 740.

Once the coder determines that the first layer pictures having no corresponding second layer pictures are to be coded, the coder proceeds to block 745 and stores video information associated with the first layer. In block 750, the coder codes a first layer picture using a previously decoded first layer picture remaining in the decoded picture buffer. For example, as illustrated in FIG. 5, base layer picture 508, which has been kept in the DPB upon switching to the second layer, may be used to code base layer picture 524 after switching back down to the base layer. The method 700 ends at block 755.

As discussed above, one or more components of video encoder 20 of FIG. 2A, video encoder 21 of FIG. 2B, video decoder 30 of FIG. 3A, or video decoder 31 of FIG. 3B (e.g., inter-layer prediction unit 128 and/or inter-layer prediction unit 166) may be used to implement any of the techniques discussed in the present disclosure, such as determining whether to code first layer pictures or second layer pictures, removing pictures from the decoded picture buffer, and coding first layer and second layer pictures using various coding methods.

In the method 700, one or more of the blocks shown in FIG. 7 may be removed (e.g., not performed) and/or the order in which the method is performed may be switched. For example, although storing of the video information associated with the second layer and the first layer is illustrated to take place after the respective determinations of whether to begin coding second layer and first layer pictures in the example of FIG. 7, the storing may take place before such determinations. In another example, the coder may never reach blocks 745 and 750 and stay at the second layer. In another example, the DPB may be entirely cleared in block 730, and block 750 may thus be omitted (there is no first layer picture remaining in the DPB). Thus, the embodiments of the present disclosure are not limited to or by the example shown in FIG. 7, and other variations may be implemented without departing from the spirit of this disclosure.

In one embodiment, the first and second layers of FIG. 7 are reference and enhancement layers, respectively. In another embodiment, the first and second layers are enhancement and reference layers, respectively.

### Implementation Embodiment #1

In one embodiment, all pictures of the switching-from layer (e.g., lower layer) are marked as “unused for reference” and potentially removed from the DPB at the switching point AU. In the decoding process section below, the new parts to be added to the specification are shown in italics.

The method of detecting when the switching occurs may differ for up-switching (e.g., switching from a lower layer to a higher layer) and down-switching (e.g., switching from a higher layer to a lower layer). In the case of up-switching, the detection of the switching is performed by checking whether more than one picture is present in the same access unit. In the case of down-switching, the detection is performed by comparing the nuh_layer_id of the picture in the current access unit and the nuh_layer_id of the picture in the previous access unit, the two access units being consecutively located in decoding order. In some implementations, the previous access unit maybe the one that is closest to the current access unit in decoding order, but also having a temporal ID of 0.

### Decoding Process for Embodiment #1

In this section, a relevant portion of the draft text of HEVC scalable extension, along with example additions that can be made thereto, is provided. Those portions pertaining to the embodiments described herein are shown in italics.

“The specifications in subclause 8.1 apply with following additions.

When the current picture has nuh_layer_id greater than 0, the following applies.

Depending on the value of separate_colour_plane_flag, the decoding process is structured as follows:

If separate_colour_plane_flag is equal to 0, the following decoding process is invoked a single time with the current picture being the output.

Otherwise (separate_colour_plane_flag is equal to 1), the following decoding process is invoked three times. Inputs to the decoding process are all NAL units of the coded picture with identical value of colour_plane_id. The decoding process of NAL units with a particular value of colour_plane_id is specified as if only a CVS with monochrome colour format with that particular value of colour_plane_id would be present in the bitstream. The output of each of the three decoding processes is assigned to one of the 3 sample arrays of the current picture, with the NAL units with colour_plane_id equal to 0, 1 and 2 being assigned to S_{L}, S_{Cb}, and S_{Cr}, respectively.

NOTE—The variable ChromaArrayType is derived as equal to 0 when separate_colour_plane_flag is equal to 1 and chroma_format_idc is equal to 3. In the decoding process, the value of this variable is evaluated resulting in operations identical to that of monochrome pictures (when chroma_format_idc is equal to 0).

The decoding process operates as follows for the current picture CurrPic.

For the decoding of the slice segment header of the first slice, in decoding order, of the current picture, the decoding process for starting the decoding of a coded picture with nuh_layer_id greater than 0 specified in subclause F.8.1.1 is invoked.

If ViewScalExtLayerFlag is equal to 1, the decoding process for a coded picture with nuh_layer_id greater than 0 specified in subclause G.8.1 is invoked.

Otherwise, when DependencyId[nuh_layer_id] is greater than 0, the decoding process for a coded picture with nuh_layer_id greater than 0 specified in subclause H.8.1.1 is invoked.

After all slices of the current picture have been decoded, the decoding process for ending the decoding of a coded picture with nuh_layer_id greater than 0 specified in subclause F.8.1.2 is invoked.”

The following language can be added to the specification:

“When the current picture is an IRAP picture, single_layer_for_non_irap_flag is equal to 1, and there is a picture in the same access unit with a lower value of nuh_layer_id than the current picture, all reference pictures in the DPB are marked as ‘unused for reference,’ and the previous decoded picture (which is in the same access unit as the current picture) and other decoded pictures with PicOutputFlag equal to 0 are removed from the DPB. Each of those pictures remaining in the DPB, except for the current picture, is removed from the DPB immediately after it is output.”

Alternatively, the following language can be added to the specification:

“When single_layer_for_non_irap_flag is equal to 1, the following applies:

The variable switchingFlag is set to 0.

When the current picture is an IRAP picture and there is a picture in the same access unit with a lower value of nuh_layer_id than the current picture, the following applies. The nuh_layer_id values of these two pictures are denoted as layerIdA and layer IdB with layerIdB greater than layerIdA, switchingFlag is set to 1, and the variable layerIdSwitch is set as layerIdA.

When there is only one picture within the current access unit and its nuh_layer_id value is less than the nuh_layer_id value of the picture in the previous access unit, switchingFlag is set to 1, layerIdSwitch is set equal to the nuh_layer_id value of the picture in the previous access unit.

When switchingFlag is equal to 1, all reference pictures with nuh_layer_id equal to layerIdSwitch in the DPB are marked as ‘unused for reference,’ and the previous decoded picture and other decoded pictures with PicOutputFlag equal to 0 are removed from the DPB. Each of those pictures remaining in the DPB, except for the current picture is removed from the DPB immediately after it is output.”

### Implementation Embodiment #2

Although an example implementation is shown below, other implementations of the same idea are also possible and should be considered to be within the scope of the present disclosure. Those portions pertaining to the embodiments described herein are shown in italics. The following video parameter set (VPS) syntax can be used:

Descriptor

vps_extension( ) {

| | |
|---|---|
| ... | |
| single_layer_for_non_irap_flag | u(1) |
| if( single_{—}layer_{—}for_{—}non_{—}irap_{—}flag ) | |

| | |
|---|---|
| keep_{—}base_{—}layer_{—}picture_{—}flag | u(1) |

...

}

The following VPS semantics can be used: “keep_base_layer_picture_flag equal to 1 specifies that at least one picture from the base layer (a reference layer with the smallest nuh_layer_id) picture is marked as ‘used for reference’ for future reference after the switching to a higher layer. keep_base_layer_picture_flag equal to 0 specifies all base layer pictures are marked as ‘unused for reference’ after a layer switching. When not present, keep_base_layer_picture_flag is inferred to be equal to 0.”

Alternatively, the following VPS semantics can be used: “keep_base_layer_picture_flag equal to 1 specifies that at least one picture from the lower layer picture is marked as ‘used for reference’ for future reference after the switching to a higher layer. keep_base_layer_picture_flag equal to 0 specifies all pictures are marked as “unused for reference” after a layer switching. When not present, keep_base_layer_picture_flag is inferred to be equal to 0.”

### Decoding Process for Embodiment #2

In this section, a relevant portion of the draft text of HEVC scalable extension, along with example additions that can be made thereto, is provided. Those portions pertaining to the embodiments described herein are shown in italics.

“The specifications in subclause 8.1 apply with following additions.

When the current picture has nuh_layer_id greater than 0, the following applies.

Depending on the value of separate_colour_plane_flag, the decoding process is structured as follows:

If separate_colour_plane_flag is equal to 0, the following decoding process is invoked a single time with the current picture being the output.

Otherwise (separate_colour_plane_flag is equal to 1), the following decoding process is invoked three times. Inputs to the decoding process are all NAL units of the coded picture with identical value of colour_plane_id. The decoding process of NAL units with a particular value of colour_plane_id is specified as if only a CVS with monochrome colour format with that particular value of colour_plane_id would be present in the bitstream. The output of each of the three decoding processes is assigned to one of the 3 sample arrays of the current picture, with the NAL units with colour_plane_id equal to 0, 1 and 2 being assigned to S_{L}, S_{Cb}, and S_{Cr}, respectively.

NOTE—The variable ChromaArrayType is derived as equal to 0 when separate_colour_plane_flag is equal to 1 and chroma_format_idc is equal to 3. In the decoding process, the value of this variable is evaluated resulting in operations identical to that of monochrome pictures (when chroma_format_idc is equal to 0).

The decoding process operates as follows for the current picture CurrPic.

For the decoding of the slice segment header of the first slice, in decoding order, of the current picture, the decoding process for starting the decoding of a coded picture with nuh_layer_id greater than 0 specified in subclause F.8.1.1 is invoked.

If ViewScalExtLayerFlag is equal to 1, the decoding process for a coded picture with nuh_layer_id greater than 0 specified in subclause G.8.1 is invoked.

Otherwise, when DependencyId[nuh_layer_id] is greater than 0, the decoding process for a coded picture with nuh_layer_id greater than 0 specified in subclause H.8.1.1 is invoked.

After all slices of the current picture have been decoded, the decoding process for ending the decoding of a coded picture with nuh_layer_id greater than 0 specified in subclause F.8.1.2 is invoked.”

The following language can be added to the specification:

“When single_layer_for_non_irap_flag is equal to 1, the following applies:

The variable switchingFlag is set to 0.

When the current picture is an IRAP picture and there is a picture in the same access unit with a lower value of nuh_layer_id than the current picture, the following applies. The nuh_layer_id values of these two pictures are denoted as layerIdA and layer IdB with layerIdB greater than layerIdA, switchingFlag is set to 1, the variable layerIdSwitch is set as layerIdA, the variable keepPicFlag is set equal to keep_base_layer_picture_flag.

When there is only one picture within the current access unit and its nuh_layer_id value is less than the nuh_layer_id value of the picture in the previous access unit, switchingFlag is set to 1, layerIdSwitch is set to the nuh_layer_id value of the picture in the previous access unit, keepPicFlag is set equal to 0.

When switchingFlag is equal to 1, the following applies in the order listed:

When keepPicFlag is equal to 1, the picture in the same access unit as that of the current picture is marked as ‘used for reference.’

All other reference pictures with nuh_layer_id equal to layerIdSwitch in the DPB are marked as ‘unused for reference,’ and other decoded pictures with PicOutputFlag equal to 0 are removed from the DPB. Each of those pictures remaining in the DPB, except for the current picture and, when keepPicFlag is equal to 1, the lower layer picture in the same access unit as the current picture, is removed from the DPB immediately after it is outputted.”

### Other Considerations

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Various embodiments of the invention have been described. These and other embodiments are within the scope of the following claims.

What is claimed is:

1. An apparatus configured to code video information, the apparatus comprising:
a memory unit configured to store video information associated with at least one of a first layer and a second layer, the first layer comprising first layer pictures and the second layer comprising second layer pictures; and
a processor in communication with the memory unit, the processor configured to:
decode one or more of the first layer pictures of the first layer;
store the one or more decoded first layer pictures in a decoded picture buffer;
determine that at least one of the second layer pictures having no corresponding first layer picture is to be coded; and
in response to determining that at least one of the second layer pictures having no corresponding first layer picture is to be coded, process an indication that at least one of the one or more decoded first layer pictures stored in the decoded picture buffer is to be removed from the decoded picture buffer.

2. The apparatus of claim 1, wherein the processor is configured to process the indication by:
signaling or receiving a flag or syntax element that indicates which one or more of the one or more decoded first layer pictures are to be kept in the decoded picture buffer; and
removing, from the decoded picture buffer, each of the one or more decoded first layer pictures that is not indicated to be kept in the decoded picture buffer.

3. The apparatus of claim 2, wherein the flag or syntax element is included in a slice header of one of the second layer pictures.

4. The apparatus of claim 2, wherein removing each of the one or more decoded first layer pictures comprises marking said each of the one or more decoded first layer pictures as not used for reference.

5. The apparatus of claim 1, wherein the processor is configured to process the indication by performing one of marking said at least one of the one or more decoded first layer pictures as not used for reference, signaling a flag or syntax element that indicates said at least one of the one or more decoded first layer pictures is to be removed from the decoded picture buffer, or receiving an indication that said at least one of the one or more decoded first layer pictures is to be removed from the decoded picture buffer.

6. The apparatus of claim 1, wherein the processor is configured to process the indication by indicating that said at least one of the one or more decoded first layer pictures is not used for reference.

7. The apparatus of claim 1, wherein the processor is configured to process the indication by indicating that every decoded first layer picture in the decoded picture buffer is to be removed from the decoded picture buffer.

8. The apparatus of claim 1, wherein the processor is further configured to:
remove all but one first layer picture from the decoded picture buffer;
determine that the first layer pictures having no corresponding second layer pictures are to be coded; and
code a new first layer picture using the first layer picture remaining in the decoded picture buffer.

9. The apparatus of claim 1, wherein the processor is further configured to:
remove from the decoded picture buffer all but one first layer picture for each temporal ID of the first layer pictures;
determine that the first layer pictures having no corresponding second layer pictures are to be coded; and
code a new first layer picture using the first layer picture remaining in the decoded picture buffer having the same temporal ID as the new first layer picture.

10. The apparatus of claim 1, wherein the processor is configured to process the indication by:
processing a flag or syntax element that indicates whether one or more of the first layer pictures stored in the decoded picture buffer are to be kept for future coding; and
removing, from the decoded picture buffer, each of the first layer pictures that is not indicated by the flag or syntax element to be kept for future coding.

11. The apparatus of claim 1, wherein the processor is further configured to:
determine that new layer pictures of a new layer having no corresponding second layer pictures are to be coded; and
code the new layer pictures,
wherein the new layer pictures have the same resolution as the first layer pictures, and the new layer has the same layer ID as the first layer.

12. The apparatus of claim 1, wherein the processor is further configured to:
in response to determining that at least one of the second layer pictures having no corresponding first layer picture is to be coded, process a dummy picture that immediately follows the most recently coded first layer picture in display order; and
cause said at least one decoded first layer picture to be removed, using the dummy picture, earlier than a time period at which said at least one decoded first layer picture would have been removed without the use of the dummy picture.

13. The apparatus of claim 1, wherein the apparatus comprises an encoder, and wherein the processor is further configured to encode the video information in a bitstream.

14. The apparatus of claim 1, wherein the apparatus comprises a decoder, and wherein the processor is further configured to decode the video information in a bitstream.

15. The apparatus of claim 1, wherein the apparatus comprises a device selected from a group consisting one or more of computers, notebooks, laptops, computers, tablet computers, set-top boxes, telephone handsets, smart phones, smart pads, televisions, cameras, display devices, digital media players, video gaming consoles, and in-car computers.

16. A method of coding video information, the method comprising:
storing video information associated with at least one of a first layer and a second layer, the first layer comprising first layer pictures and the second layer comprising second layer pictures;
decoding one or more of the first layer pictures of the first layer;
storing the one or more decoded first layer pictures in a decoded picture buffer;
determining that at least one of the second layer pictures having no corresponding first layer picture is to be coded; and
in response to determining that at least one of the second layer pictures having no corresponding first layer picture is to be coded, processing an indication that at least one of the one or more decoded first layer pictures stored in the decoded picture buffer is to be removed from the decoded picture buffer.

17. The method of claim 16, wherein processing the indication comprises:
signaling or receiving a flag or syntax element that indicates which one or more of the one or more decoded first layer pictures are to be kept in the decoded picture buffer; and
removing, from the decoded picture buffer, each of the one or more decoded first layer pictures that is not indicated to be kept in the decoded picture buffer.

18. The method of claim 16, wherein processing the indication comprises one of marking said at least one of the one or more decoded first layer pictures as not used for reference, signaling a flag or syntax element that indicates said at least one of the one or more decoded first layer pictures is to be removed from the decoded picture buffer, or receiving an indication that said at least one of the one or more decoded first layer pictures is to be removed from the decoded picture buffer.

19. The method of claim 16, wherein said at least one of the second layer pictures having no corresponding first layer picture is part of an access unit that contains a single picture.

20. The method of claim 16, wherein the first layer pictures have a first resolution, and the second layer pictures have a second resolution that is higher than the first resolution.

21. The method of claim 16, wherein said at least one of the one or more decoded first layer pictures is removed from the decoded picture buffer after decoding a second layer picture based the most recently decoded first layer picture using inter-layer prediction.

22. The method of claim 16, further comprising:
removing all but one first layer picture from the decoded picture buffer;
determining that the first layer pictures having no corresponding second layer pictures are to be coded; and
coding a new first layer picture using the first layer picture remaining in the decoded picture buffer.

23. The method of claim 16, further comprising:
removing from the decoded picture buffer all but one first layer picture for each temporal ID of the first layer pictures;
determining that the first layer pictures having no corresponding second layer pictures are to be coded; and
coding a new first layer picture using the first layer picture remaining in the decoded picture buffer having the same temporal ID as the new first layer picture.

24. The method of claim 16, wherein processing the indication comprises:
processing a flag or syntax element that indicates whether one or more of the first layer pictures stored in the decoded picture buffer are to be kept for future coding; and
removing, from the decoded picture buffer, each of the first layer pictures that is not indicated by the flag or syntax element to be kept for future coding.

25. The method of claim 16, further comprising:
determining that new layer pictures of a new layer having no corresponding second layer pictures are to be coded; and
coding the new layer pictures,
wherein the new layer pictures have the same resolution as the first layer pictures, and the new layer has the same layer ID as the first layer.

26. The method of claim 16, further comprising:
in response to determining that at least one of the second layer pictures having no corresponding first layer picture is to be coded, processing a dummy picture that immediately follows the most recently coded first layer picture in display order; and
causing said at least one decoded first layer picture to be removed, using the dummy picture, earlier than a time period at which said at least one decoded first layer picture would have been removed without the use of the dummy picture.

27. A non-transitory computer readable medium comprising code that, when executed, causes an apparatus to perform a process comprising:
storing video information associated with at least one of a first layer and a second layer, the first layer comprising first layer pictures and the second layer comprising second layer pictures;
decoding one or more of the first layer pictures of the first layer;
storing the one or more decoded first layer pictures in a decoded picture buffer;
determining that at least one of the second layer pictures having no corresponding first layer picture is to be coded; and
in response to determining that at least one of the second layer pictures having no corresponding first layer picture is to be coded, processing an indication that at least one of the one or more decoded first layer pictures stored in the decoded picture buffer is to be removed from the decoded picture buffer.

28. The computer readable medium of claim 27, wherein processing the indication comprises one of marking said at least one of the one or more decoded first layer pictures as not used for reference, signaling a flag or syntax element that indicates said at least one of the one or more decoded first layer pictures is to be removed from the decoded picture buffer, or receiving an indication that said at least one of the one or more decoded first layer pictures is to be removed from the decoded picture buffer.

29. A video coding device configured to code video information, the video coding device comprising:
means for storing video information associated with at least one of a first layer and a second layer, the first layer comprising first layer pictures and the second layer comprising second layer pictures;
means for decoding one or more of the first layer pictures of the first layer;
means for storing the one or more decoded first layer pictures in a decoded picture buffer;
means for determining that at least one of the second layer pictures having no corresponding first layer picture is to be coded; and
means for processing an indication, in response to determining that at least one of the second layer pictures having no corresponding first layer picture is to be coded, that at least one of the one or more decoded first layer pictures stored in the decoded picture buffer is to be removed from the decoded picture buffer.

30. The video coding device of claim 29, wherein said means for processing the indication comprises one of:
means for marking said at least one of the one or more decoded first layer pictures as not used for reference;
means for signaling a flag or syntax element that indicates said at least one of the one or more decoded first layer pictures is to be removed from the decoded picture buffer; or
means for receiving an indication that said at least one of the one or more decoded first layer pictures is to be removed from the decoded picture buffer.
